(19) United States
(12) Patent Application Publication
(10) Pub. No.: US 2016/0104092 A1
(43) Pub. Date: Apr. 14, 2016

(54) SYSTEMS AND METHODS FOR MANAGING BUSINESS AWARD WORKFLOW

(71) Applicant: The Procter & Gamble Company, Cincinnati, OH (US)

(72) Inventors: Curtis Brunswick, Cincinnati, OH (US); Adam Matthew Lux, Milford, OH (US); Simon Cai, Mason, OH (US); Mert Kacmaz, Cincinnati, OH (US)

(21) Appl. No.: 14/852,888

(22) Filed: Sep. 14, 2015

Related U.S. Application Data
(60) Provisional application No. 62/061,169, filed on Oct. 8, 2014.

(51) Int. Cl. G06Q 10/06

(52) U.S. Cl. CPC G06Q 10/06393

(57) ABSTRACT

Included are embodiments for managing business award workflow. Some embodiments include receiving information related to a policy, receiving information related to a project, where the project includes a business award to a supplier, and comparing the policy with the information to determine whether the business award adheres to the policy. Similarly, some embodiments include, in response to determining that the business award adheres to the policy, sending at least a portion of the information to a predetermined approver, in response to determining that the business award does not adhere to the policy, preventing the business award to occur and identify a reason that the business award does not meet the policy.

### FIELD OF THE INVENTION

The present application relates generally to managing business award workflow and specifically to providing a computing infrastructure for users to create and manage strategies, projects, and/or business awards.

### BACKGROUND OF THE INVENTION

As a background, an organization may include a plurality of different business units, subsidiaries, or other divisions that span a plurality of different jurisdictions. Accordingly, the organization may develop policies for awarding business by a division with a third party supplier. Because of the legal and business ramifications of the award, the organization may develop policies to ensure that all divisions perform consistent and appropriate measures in making the award. However, current solutions are unable to easily provide a user with a tool that ensures that the award being made adheres to the policies. Additionally, these current solutions are unable to adequately monitor awards, projects, and/or other actions to ensure that the policies are followed.

### SUMMARY OF THE INVENTION

Included are embodiments for managing business award workflow. Some embodiments include receiving information related to a policy, where the policy is associated with purchasing an item, receiving information related to a project, where the project includes a business award to a supplier, and where the information includes data related to the business award, and comparing the policy with the information to determine whether the business award adheres to the policy. Similarly, some embodiments include, in response to determining that the business award adheres to the policy, sending at least a portion of the information to a predetermined approver for approval, and in response to determining that the business award does not adhere to the policy, preventing the business award to occur and identify a reason that the business award does not meet the policy. Some embodiments include providing a user interface that includes at least a portion of the information related to the project, including an indication regarding whether the business award adheres to the policy, where the user interface further comprises an option to create a new project. Also included are embodiments of a computing device.

Also included are embodiments of a system. Some embodiments include a memory component that stores logic that, when executed by a processor, causes the processor to receive information related to a policy, where the policy is associated with purchasing an item, receive information related to a project, where the project includes a business award to a supplier, and where the information includes data related to the business award, and compare the policy with the information to determine whether the business award adheres to the policy. Some embodiments may also cause the processor to, in response to determining that the business award adheres to the policy, send at least a portion of the information to a predetermined approver for approval, and in response to determining that the business award does not adhere to the policy, prevent the business award to occur and identify a reason that the business award does not meet the policy. In some embodiments, the logic causes the system to provide a user interface that includes at least a portion of the information related to the project, including an indication regarding whether the business award adheres to the policy.

Also included are embodiments of a non-transitory computer-readable medium. Some embodiments of the non-transitory computer-readable medium include logic that causes a computing device to receive information related to a policy, where the policy is associated with purchasing an item, receive information related to a strategy, where the strategy includes a plurality of projects, at least one of the plurality of projects including a business award to a supplier, and where the information includes data related to the business award, and compare the policy with the information to determine whether the business award adheres to the policy. Similarly, some embodiments cause the computing device to, in response to determining that the business award adheres to the policy, send at least a portion of the information to a predetermined approver for approval, and in response to determining that the business award does not adhere to the policy, prevent the business award to occur and identify a reason that the business award does not meet the policy. In some embodiments, the logic causes the computing device to provide a user interface that includes at least a portion of the information related to the project, including an indication regarding whether the business award adheres to the policy, where the user interface further comprises an option to add a new project to the strategy.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computer environment for managing business award workflow, according to embodiments described herein;

FIG. 2 depicts a remote computing device for managing business award workflow, according to embodiments described herein;

FIG. 3 depicts a user interface for providing a workflow dashboard, according to embodiments described herein;

FIG. 4 depicts a user interface for creating a strategy, according to embodiments described herein;

FIG. 5 depicts a user interface for assigning a team to a strategy, according to embodiments described herein;

FIG. 6 depicts a user interface for gathering strategy analysis, according to embodiments described herein;

FIG. 7 depicts a user interface for approving a strategy, according to embodiments described herein;

FIG. 8 depicts a user interface for cloning a strategy, according to embodiments described herein;

FIG. 9 depicts a user interface for creating a project, according to embodiments described herein;

FIG. 10 depicts a user interface for assigning a team to a project, according to embodiments described herein;

FIG. 11 depicts a user interface for developing a sourcing a plan, according to embodiments described herein;

FIG. 12 depicts a user interface for a request for price inquiry, according to embodiments described herein;

FIG. 13 depicts a user interface for providing negotiation information, according to embodiments described herein;

FIG. 14 depicts a user interface for providing details related to a project, according to embodiments described herein;

FIGS. 15A-15B depict a user interface for providing additional details related to the project, according to embodiments described herein;

FIG. 16 depicts a user interface for providing accounting information related to a project, according to embodiments described herein;

FIG. 17 depicts a user interface for providing overview information related to a project, according to embodiments described herein;

FIG. 18 depicts a user interface for providing approval information related to a project, according to embodiments described herein;

FIG. 19 depicts a user interface for providing completion data related to a contract of a project, according to embodiments described herein;

FIG. 20 depicts a user interface for providing collection information related to a project, according to embodiments described herein;

FIG. 21 depicts a user interface for providing cost information related to a project, according to embodiments described herein;

FIG. 22 depicts a user interface for cloning a project, according to embodiments described herein;

FIG. 23 depicts a user interface for providing an administrator portal, according to embodiments described herein;

FIG. 24 depicts a user interface for an administrator to create a new template for use in a project and/or strategy, according to embodiments described herein;

FIG. 25 depicts a user interface for creating a new template, according to embodiments described herein;

FIG. 26 depicts a user interface for searching for a project and/or strategy, according to embodiments described herein; and

FIG. 27 depicts a flowchart for managing business award workflow, according to embodiments described herein.

### DETAILED DESCRIPTION OF THE INVENTION

Embodiments disclosed herein include systems and methods for managing business award workflow. Specifically, one embodiment may be configured to provide an electronic tool that provides a plurality of user interfaces for taking a user and/or purchasing division through a series of data inputs. The tool may then determine the policies to follow for a particular business award, as well as provide approval hurdles, and general workflow management.

To this end, one or more user interfaces may be provided for a user to enter data regarding a project or business award. Regardless, the user may enter information regarding the project and/or business award, which may include a region, spend pool, supplier, date, award value, sourcing buyer, an approver of the project and/or business award, a sourcing strategy (negotiated, RFP, other). Based on the inputs provided to these fields, additional fields may be provided to fully document the project and/or business award. Once the fields are populated, information regarding the project and/or business award may be provided as a dashboard to others who have been granted appropriate access. These team members may then supplement the project with additional business awards, alter data for a project, and/or provide other information, depending on the level of access. Additionally, some embodiments may be configured to determine a spend amount for a predetermined time period and/or other statistics for a particular division, supplier, etc.

Additionally, some embodiments are configured for automatic approvals with business award orders. As an example, if a business award has already been approved in the system, then there will be no need for buyer approval on the business award order. Such embodiments reduce delays when making a business awarding business. Accordingly, embodiments may be configured to enable integrated collaboration and knowledge retention throughout the life of sourcing cycle, e.g., a collaboration feature is available from kicking off the sourcing effort until BAR completion/approval, contract tracking, and/or saving tracking.

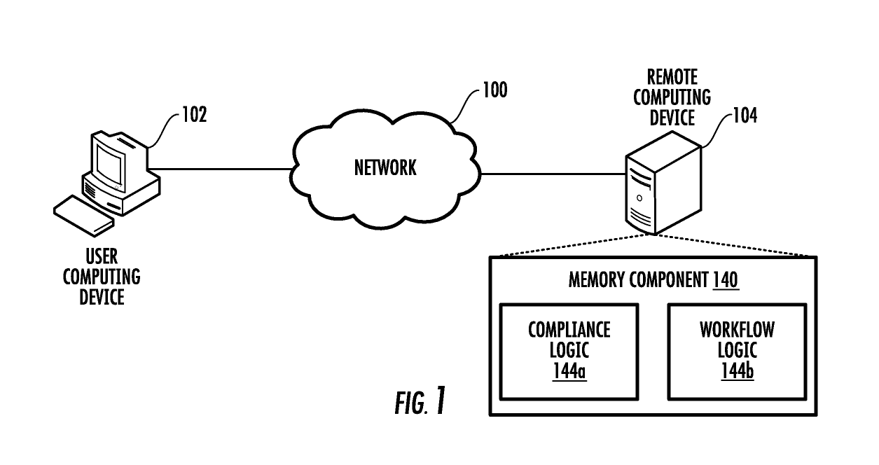

Referring now to the drawings, FIG. 1 depicts a computer environment for managing business award workflow, according to embodiments described herein. As illustrated, the computing environment may include a network 100, which may include a wide area network (wired or wireless), such as the internet, a cellular network, or other communications network for communicating devices across a wide area. Additionally, the network 100 may include a wired or wireless local area network for communicating data, as described herein.

Coupled to the network 100 is a computing device, such as user computing device 102. The user computing device 102 may be configured for users to create and/or edit a strategy or project for verification and/or implementation. As discussed in more detail below, the user computing device 102 may additionally interface with the remote computing device 104 to receive criteria associated with the strategy and/or or project.

The remote computing device 104 may include a memory component 140 that stores data compliance logic 144a and workflow logic 144b. The compliance logic 144a may include one or more components, such as for determining whether a particular business award complies with a predetermined internal enterprise policy. The workflow logic 144b may be configured to cause the remote computing device 104 to provide the user interfaces and/or otherwise facilitate the workflow of a project and/or strategy.

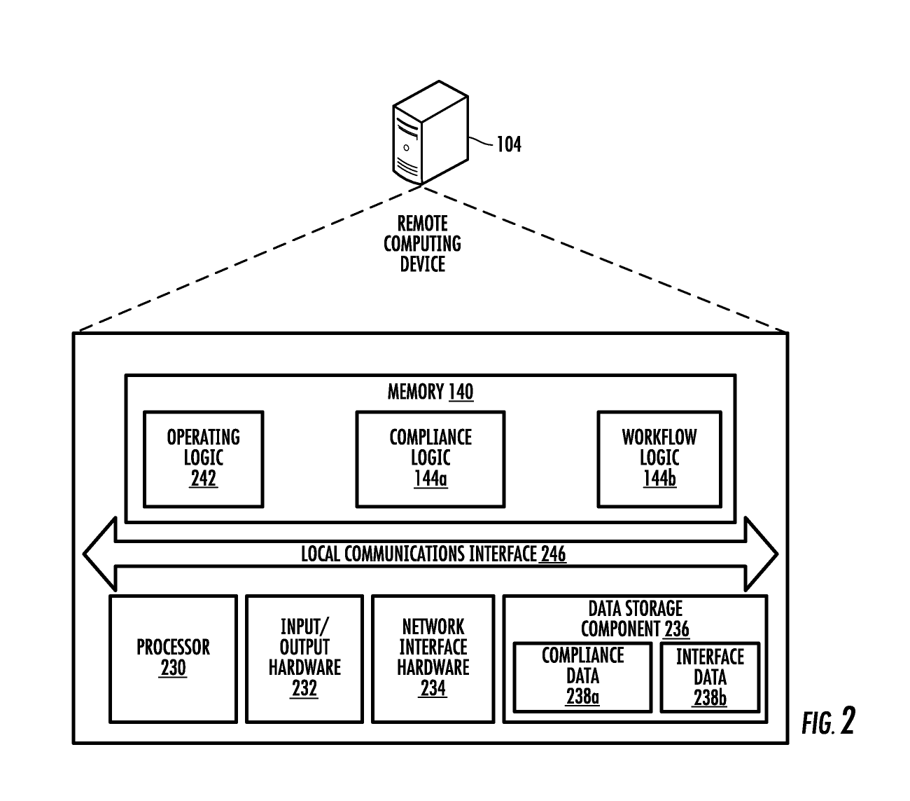

FIG. 2 depicts a remote computing device 104 for managing business award workflow, according to embodiments described herein. As illustrated, the remote computing device 104 includes a processor 230, input/output hardware 232, a network interface hardware 234, a data storage component 236 (which stores compliance data 238a and/or interface data 238b), and a memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable mediums. Depending on the particular embodiment, these non-transitory computer-readable mediums may reside within the remote computing device 104 and/or external to the remote computing device 104.

The memory component 140 may store operating logic 242, the compliance logic 144a, and the workflow logic 144b. Each of these logic components may include a plurality of different pieces of logic, each of which may be embodied as a computer program, firmware, and/or hardware, as an example. A local interface 246 is also included in FIG. 2 and may be implemented as a bus or other communication interface to facilitate communication among the components of the remote computing device 104.

The processor 230 may include any processing component operable to receive and execute instructions (such as from a data storage component 236 and/or the memory component 134). As described above, the input/output hardware 232 may include and/or be configured to interface with the components of FIG. 2.

The network interface hardware 234 may include and/or be configured for communicating with any wired or wireless networking hardware, including an antenna, a modem, a LAN port, wireless fidelity (Wi-Fi) card, WiMax card, mobile communications hardware, and/or other hardware for communicating with other networks and/or devices. From this connection, communication may be facilitated between the remote computing device 104 and other computing devices.

The operating logic 242 may include an operating system and/or other software for managing components of the remote computing device 104. Similarly, as discussed above, the compliance logic 144a may reside in the memory component 140 and may be configured to cause the processor 230 to determine whether a particular business award complies with a predetermined policy. The workflow logic 144b may be configured to cause the memory component 140 to cause the processor 230 to provide user interfaces and/or otherwise facilitate workflow as described herein.

It should be understood that while the components in FIG. 2 are illustrated as residing within the remote computing device 104, this is merely an example. In some embodiments, one or more of the components may reside external to the remote computing device 104 or within other devices, such as those depicted in FIG. 1. It should also be understood that, while the remote computing device 104 is illustrated as a single device, this is also merely an example. In some embodiments, the compliance logic 144a and the workflow logic 144b may reside on different computing devices. As an example, one or more of the functionalities and/or components described herein may be provided by the user computing device 102 and/or the remote computing device 104.

Additionally, while the remote computing device 104 is illustrated with the compliance logic 144a and the workflow logic 144b as separate logical components, this is also an example. In some embodiments, a single piece of logic may provide the described functionality. It should also be understood that while the compliance logic 144a and the workflow logic 144b are described herein as the logical components, this is also an example. Other components may also be included, depending on the embodiment.

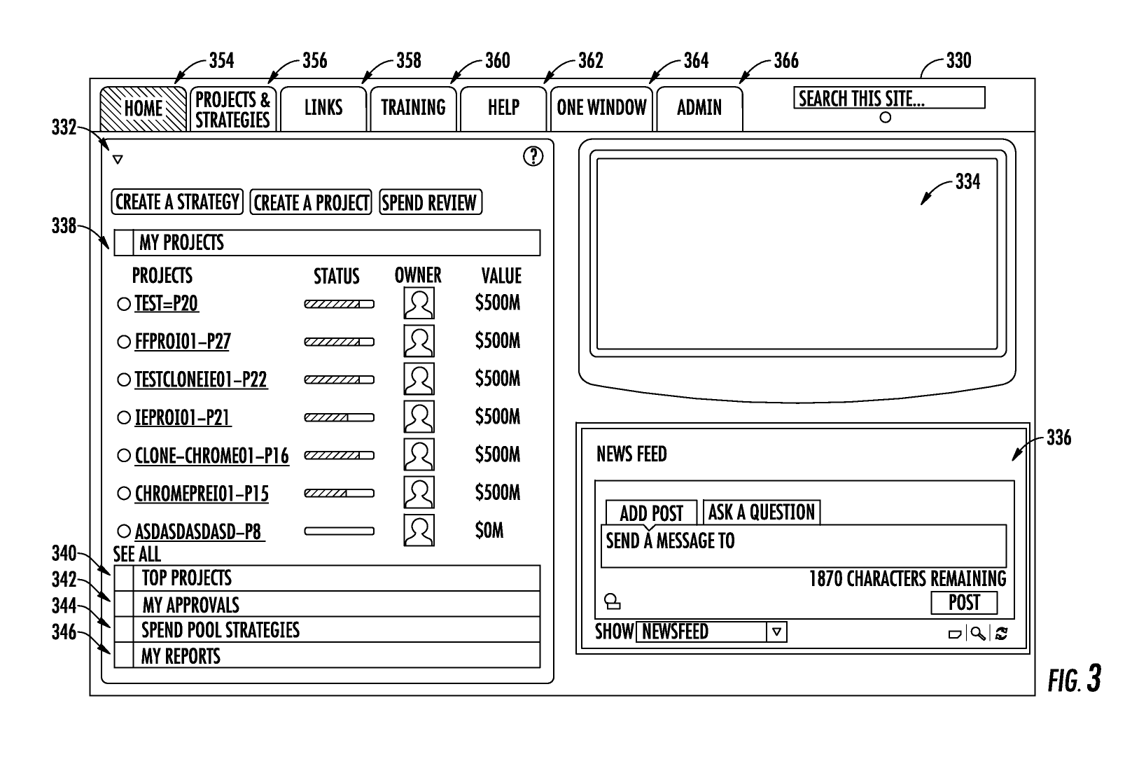

FIG. 3 depicts a user interface 330 for providing a workflow dashboard, according to embodiments described herein. As illustrated, the user interface 330 may be configured to provide a plurality of options related to creating a strategy, project, and/or otherwise provide a workflow for the strategy, project, or business award. Specifically, the user interface 330 includes a workflow section 332, a whiteboard section 334, and a newsfeed section 336. The workflow section 332 may include a my projects tab 338, which includes one or more projects that the user has access. The projects may include a name, a status, an owner, and a value. Similarly, a top projects tab 340 may also be included for identifying the top projects in a particular business group, division, company, etc. A my approvals tab 342 may provide the user with approvals that are currently needed in a business allocation, project, and/or contract as well as approvals that have been recently received. A spend pool strategies tab 344 may also be included for providing strategies for particular spend pools that the user has access. As an example, the spend pools may or may not be associated with a particular project. As such, the spend pool strategies tab 344 may provide the user with strategies so that the user can identify the appropriate action to take for a particular spend pool. The whiteboard section 334 may provide the user with general information regarding the system. This information may include general information regarding strategies and/or projects.

The user interface 330 also includes a create strategy option 348, a create project option 350, and a spend review option 352. In response to selection of the create strategy option 348, one or more options may be provided for creating a new strategy, as described in more detail below. In response to selection of the create project option 350, one or more options may be provided for creating a new project (also described below). Depending on the particular embodiment, one or more projects may be part of a strategy; however, some projects may not be associated with any strategy.

Also included in the user interface 330 are a home option 354, a projects and strategies option 356, a links option 358, a training option 360, a help option 362, a one window option 364, and an admin option 366. In response to selection of the home option 354, the user interface 330 may be provided. In response to selection of the projects and strategies option 356, a listing of the user's projects and/or strategies may be provided. In response to selection of the links option 358, helpful links may be provided. In response to selection of the training option 360, video and/or other materials may be provided to assist the user in utilizing the system and/or complying with one or more predetermined policies. In response to selection of the help option 362, technical help may be provided. In response to selection of the one window option 364, an interface related to other functionality may be provided. In response to selection of the admin option 366, access to administrative functions may be provided, as described in more detail below.

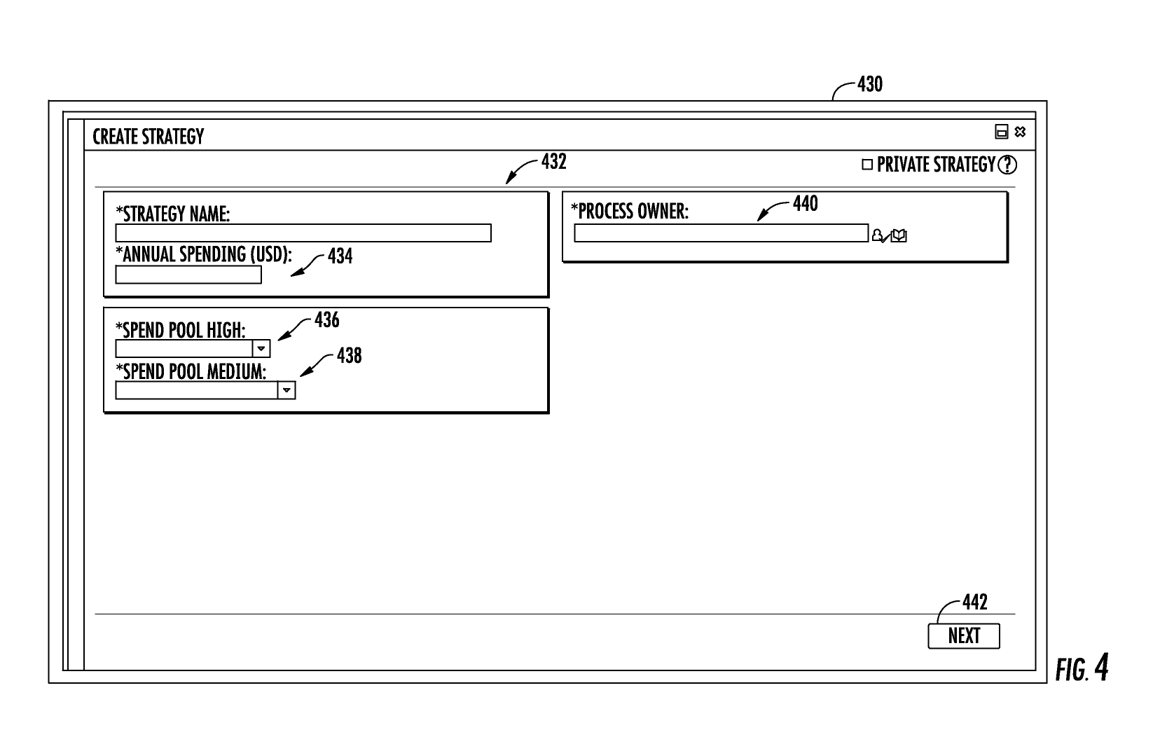

FIG. 4 depicts a user interface 430 for creating a strategy, according to embodiments described herein. In response to selection of the create strategy option 348, the user interface 430 may be provided. Specifically, if a user wishes to create an overall strategy, which includes one or more projects, the user interface 430 may facilitate this process. Included in the user interface 430 are a strategy name field 432, a spend field 434, a spend pool high field 436, a spend pool medium field 438, and a process owner field 440. In the strategy name field 432, a user may enter a name of the new strategy. In the spend field 434, the user may enter the annual spend that is allowed for this strategy. In the spend pool high field 436, the user may select an entity responsible for a high spend pool. In the spend pool medium field 438, the user may select an entity responsible for a medium spend pool. In the process owner field 440, the user may indicate the owner of the process. Once the fields are populated, the user may select a next option 442 for proceeding to a next user interface.

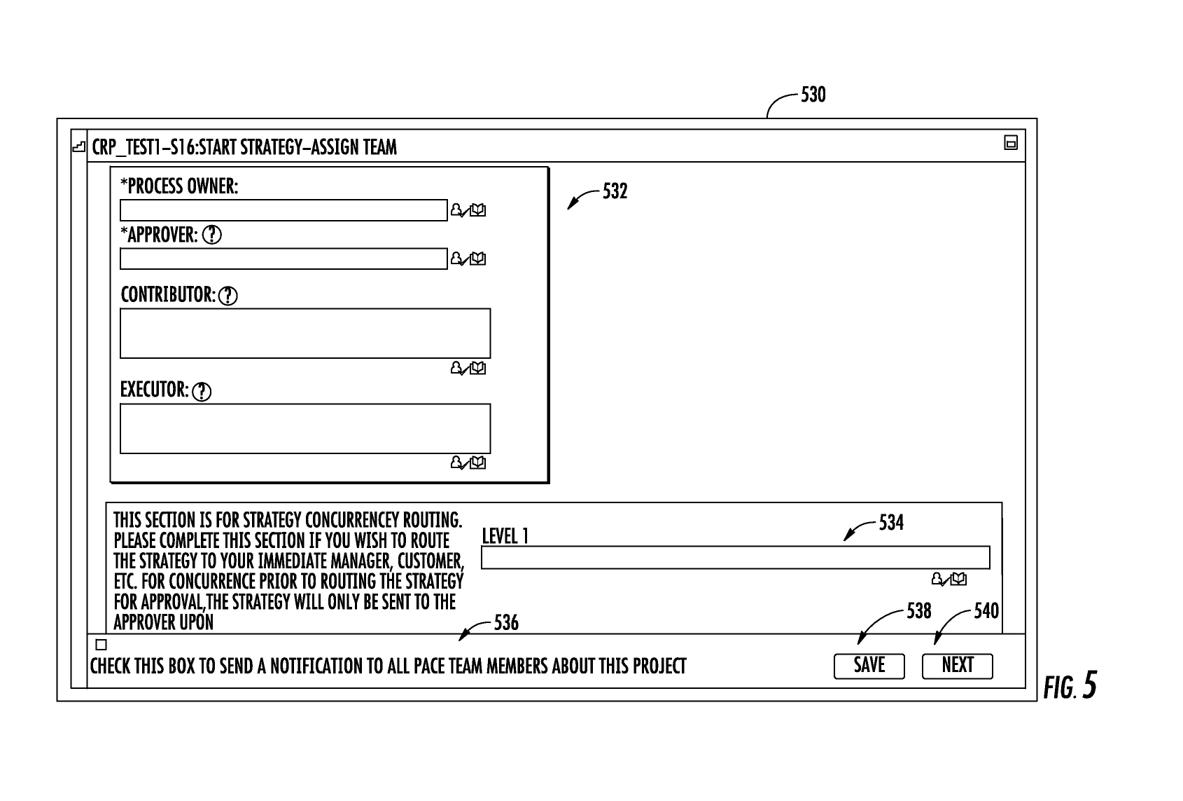

FIG. 5 depicts a user interface 530 for assigning a team to a strategy, according to embodiments described herein. In response to selection of the next option 442 from FIG. 4, the user interface 530 may be provided. Specifically, the user interface 530 includes an associated persons section 532, which in includes a process owner field an approver field, a contributor field, and an executor field. The process owner field may be the same field as the process owner field 440 from FIG. 4 (however, this is not a requirement). The approver field may provide the user with an option to identify the person who would approve a business award or other action within the strategy (and/or project). The contributor field may receive an identification of those persons who will contribute to the strategy and/or process. These persons may then be provided with information on this strategy via a respective dashboard, similar to the user interface 330 from FIG. 3. The executor field may receive an identification of an outside person who would act as an executor of the strategy and/or project.

Also included in the user interface 530 is a routing area 534. The routing area 534 may include a field for receiving an identification of any persons to whom the strategy may be routed. This might include managers, customers, and/or others. The routing area 534 may also include an option to send notification to all team members. In response to selection of a save option 538, the strategy and/or project may be saved for later viewing and/or editing. In response to selection of a next option 540, another user interface may be provided.

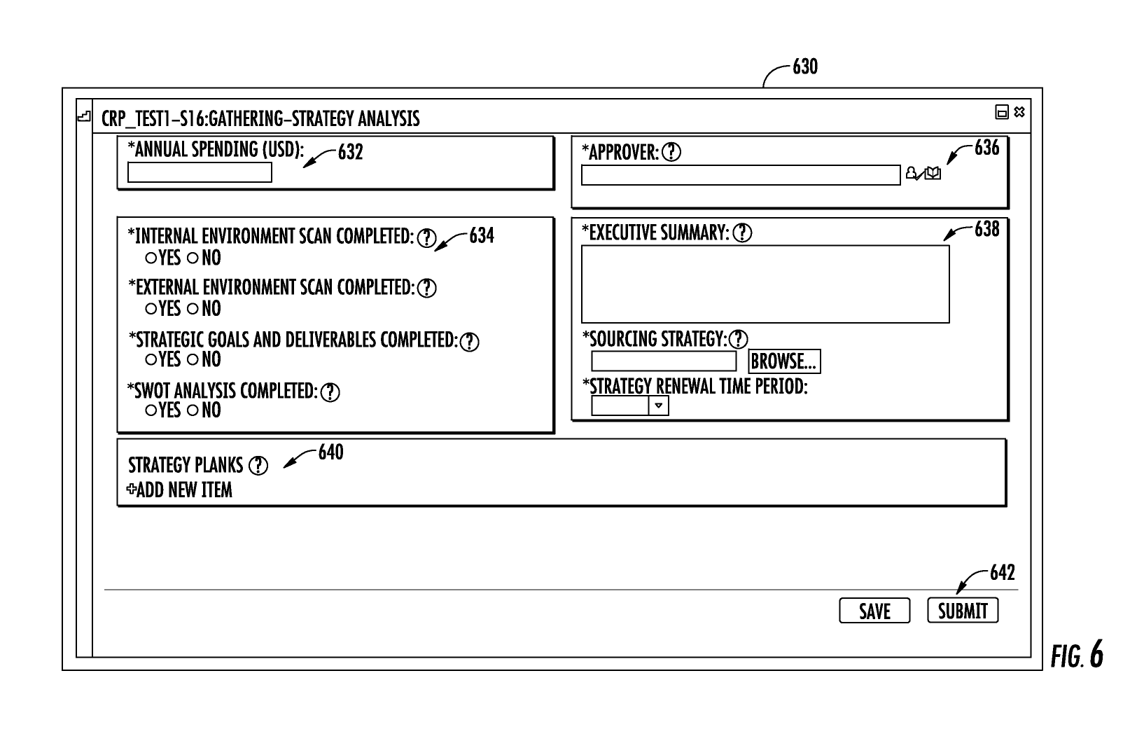

FIG. 6 depicts a user interface 630 for gathering strategy analysis, according to embodiments described herein. In response to selection of the next option 540, the user interface 630 may be provided. Specifically, the user interface 630 may include an annual spend section 632, a completion section 634, an approver section 636, a summary section 638, and a strategy planks section 640. The annual spend section 632 may include a field to receive an annual spend amount for the strategy. This may be the same field as the spend field 434 in FIG. 4, but this is not a requirement.

The completion section 634 may include an option to identify whether an internal environment scan has been completed, whether an external environmental scan has been completed, whether strategic goals and deliverables have been completed, and whether a strengths, weaknesses, opportunities and threats (SWOT) analysis has been performed.

The approver section 636 includes an approver field, which may the same field as the approver field in the associated persons section 532 from FIG. 5. The summary section 638 may include an executive summary field for the user to enter an executive summary associated with the strategy. Additionally, a sourcing strategy field may be provided for the user to identify a sourcing strategy. A strategy renewal time period field is also included for identifying a period for the strategy. The strategy planks section 640 includes an option to add a new item to the strategy planks. In response to selection of a submit option 642, the process may continue.

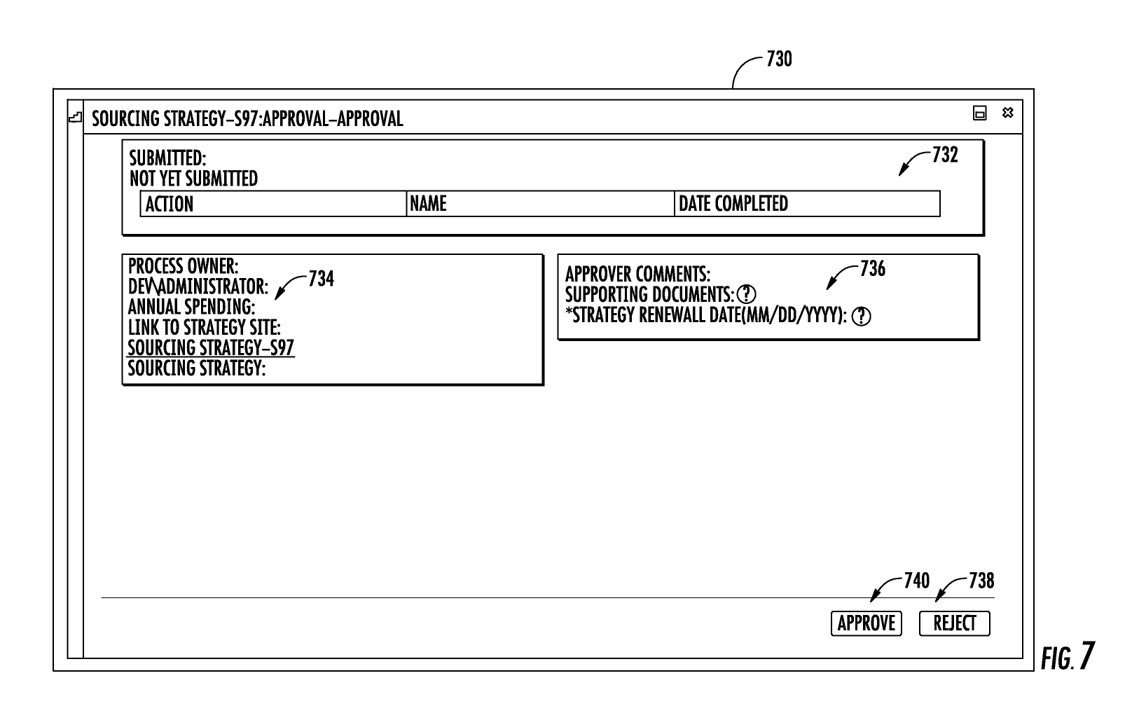

FIG. 7 depicts a user interface 730 for approving a strategy, according to embodiments described herein. In response to selection of the submit option 642 from FIG. 6, the user interface 730 may be provided. Specifically, the user interface 730 may include a status section 732, an informational section 734, and an external source section 736. The status section 732 may provide an indication of a current status of a strategy and/or project. Specifically, an action column may be provided, along with a name column and a status column. The informational section 734 may include a process owner, administrator, annual spending, sourcing strategy, as well as a link to the strategy. The status section 732 may provide approver comments, supporting documents, a strategy renewal date, and/or other similar information. Also included are a reject option 738 for rejecting the current strategy and an approve option 740 for approving the current strategy.

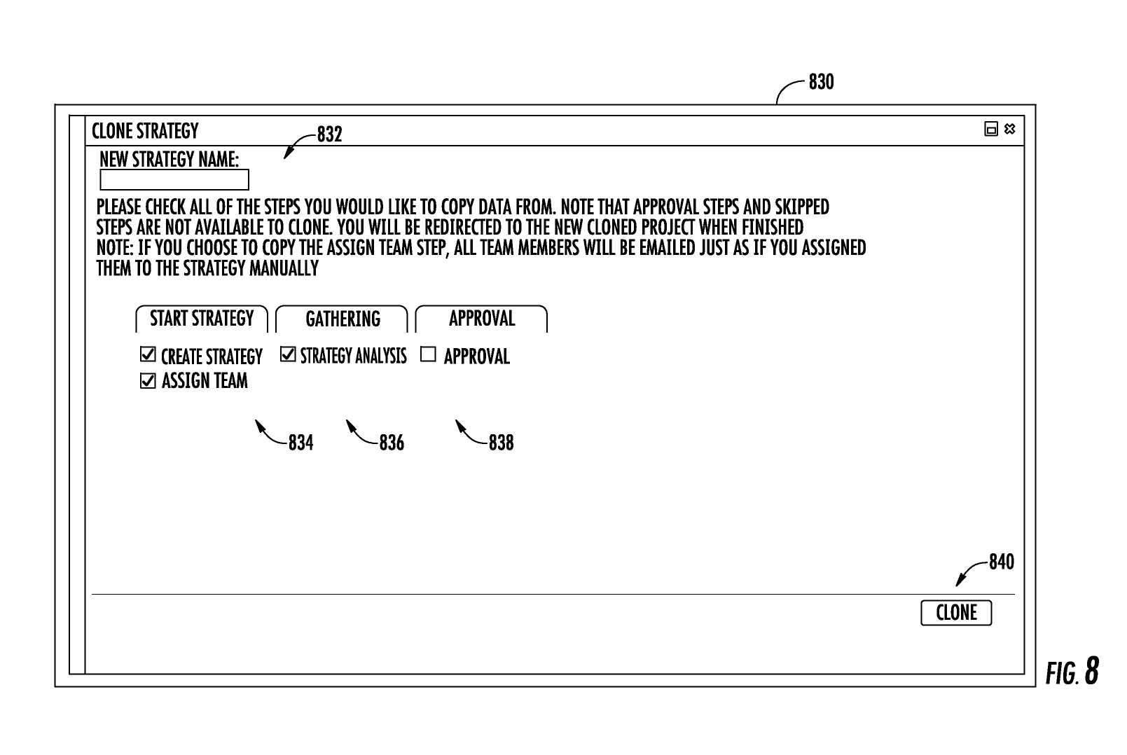

FIG. 8 depicts a user interface 830 for cloning a strategy, according to embodiments described herein. As illustrated in FIG. 8, the user interface 830 includes a new strategy name field 832 for receiving a name of the cloning strategy that will result. Also included are start strategy options 834, gathering options 836, and approval options 838. A clone option 840 is also included for cloning the selected strategy.

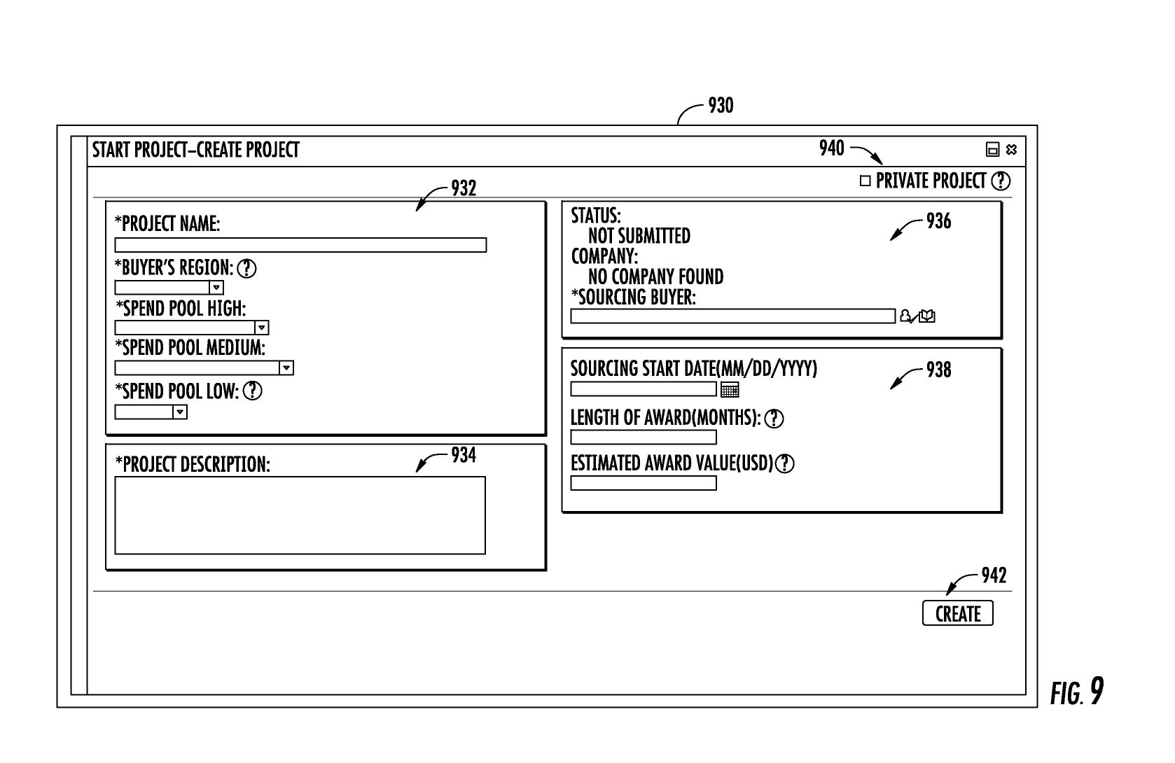

FIG. 9 depicts a user interface 930 for creating a project, according to embodiments described herein. In response to selection of the create a project option 350, the user interface 930 may be provided. Specifically, the user interface 930 may include a basic information section 932, a project description section 934, a status section 936, and a duration section 938. The basic information section 932 may include a project name field, a buyers region field, a spend pool high field, a spend pool medium field, and a spend pool low field.

Depending on the particular embodiment, the information entered into the fields described for the strategy, discussed with reference to FIG. 4 may automatically be populated into the corresponding fields for the project (assuming the project is entered as part of the strategy). However, as some embodiments may include different information for a strategy and project, some embodiments may not be configured with this feature.

Additionally, the project description section 934 may include a field for the user to enter a description of the project. The status section 936 may provide a current status, a company, as well as provide a sourcing buyer field for the user to enter the sourcing buyer for the current project. The duration section 938 may include a sourcing start date field, a length of award field, and an estimated award value field. Also included is a create option 942 for creating the project.

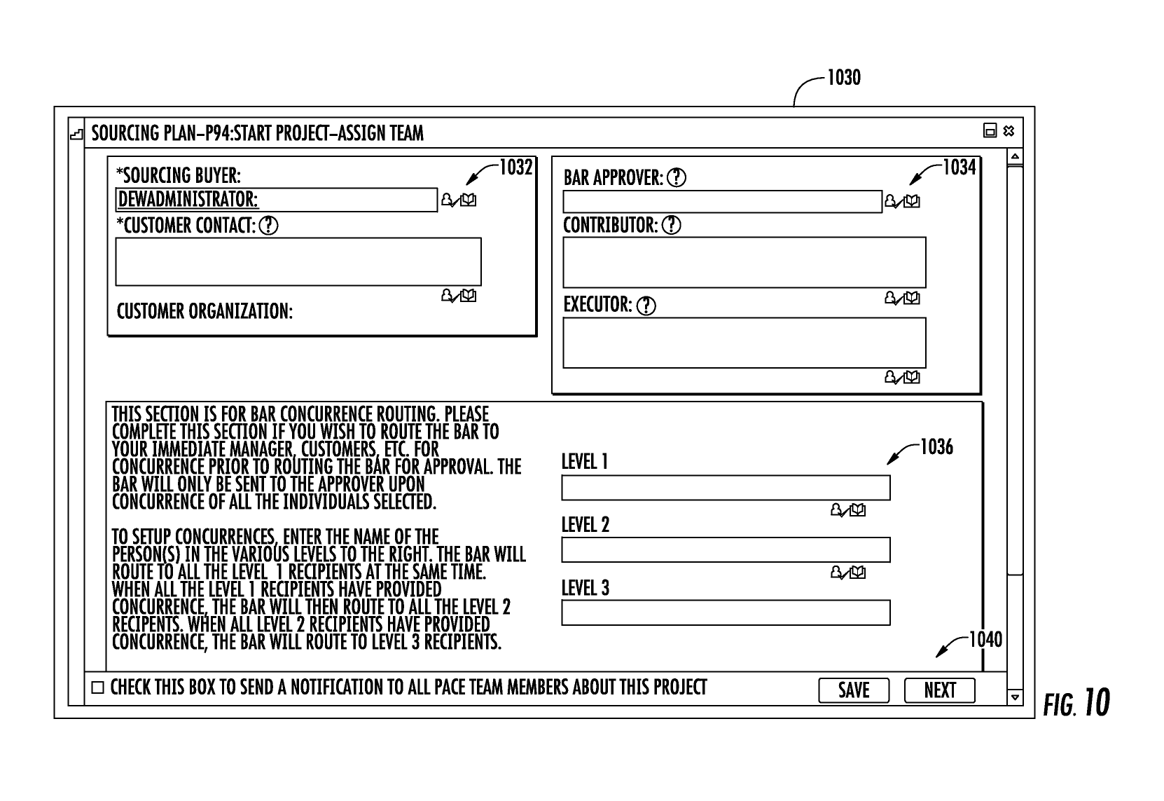

FIG. 10 depicts a user interface 1030 for assigning a team to a project, according to embodiments described herein. As illustrated, the user interface 1030 includes a contact section 1032, a personnel section 1034, and a routing area 1036. Specifically, the contact section 1032 includes a sourcing buyer field and a customer contact field for the user to enter the associated persons and/or entities. Similarly, the personnel section 1034 may include an approver field, a contributor field, and an executor field. The routing area 1036 includes fields for one or more levels associated with whom information may be shared. A next option 1040 may also be provided for proceeding to a subsequent user interface.

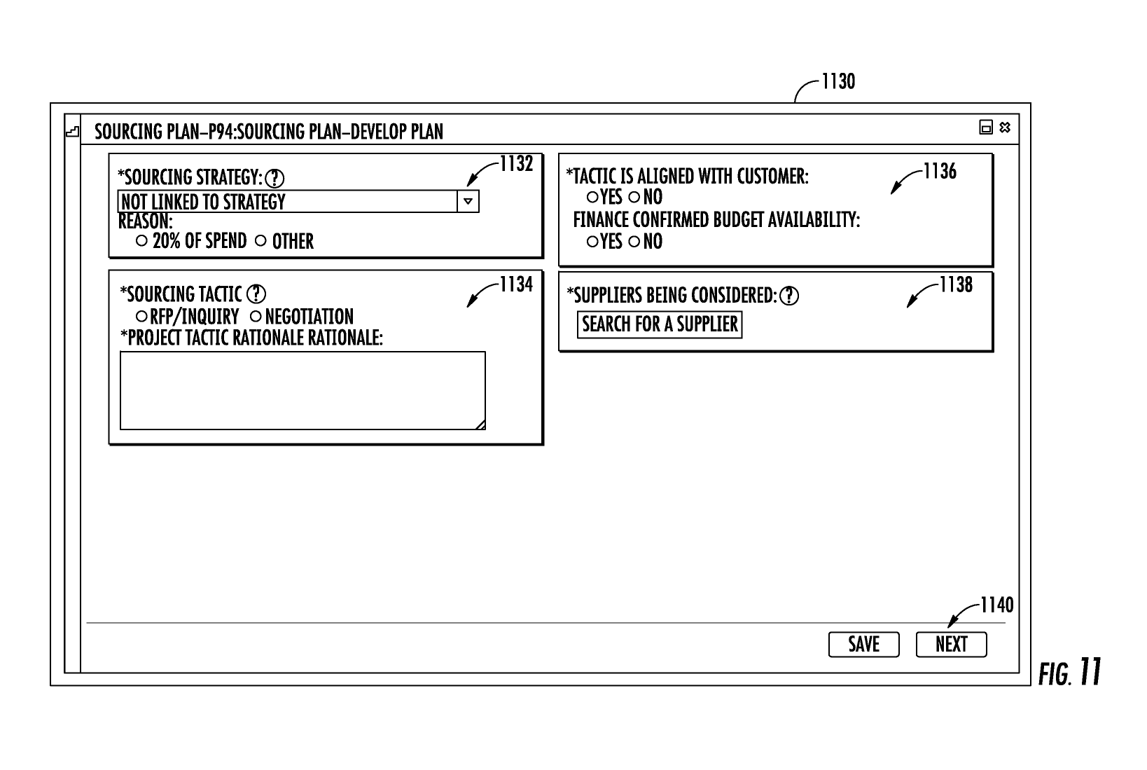

FIG. 11 depicts a user interface 1130 for developing a sourcing a plan, according to embodiments described herein. The user interface 1130 may be provided in response to a user selection of the next option 1040 from FIG. 10. As illustrated, the user interface 1130 includes a strategy section 1132, a tactic section 1134, a tactic follow-up section 1136, and a suppliers section 1138. Specifically, the strategy section 1132 may include a sourcing strategy field for the user to identify with which strategy the project is associated. A reason field may also be provided to identify a reason for associating the project to a strategy. As an example, a project may be associated with a strategy when the project consumes a predetermined percentage of the total budget for that strategy (e.g., 5%, 10%, 20%, etc.). The tactic section 1134 includes a sourcing process field to identify whether the sourcing is being performed via a request for quote (RFQ), a request for proposal (RFP), via negotiation, and/or via other mechanism. A rationale field may also be provided for the user to identify a rationale for the selected sourcing process. In the tactic follow-up section 1136, options for identifying whether the tactic is aligned with a customer and/or whether internal finance has confirmed the budget availability for this project. In the suppliers section 1138 is a field for identifying one or more suppliers who may be utilized for the project. Also included is a next option 1140 for proceeding to a subsequent user interface.

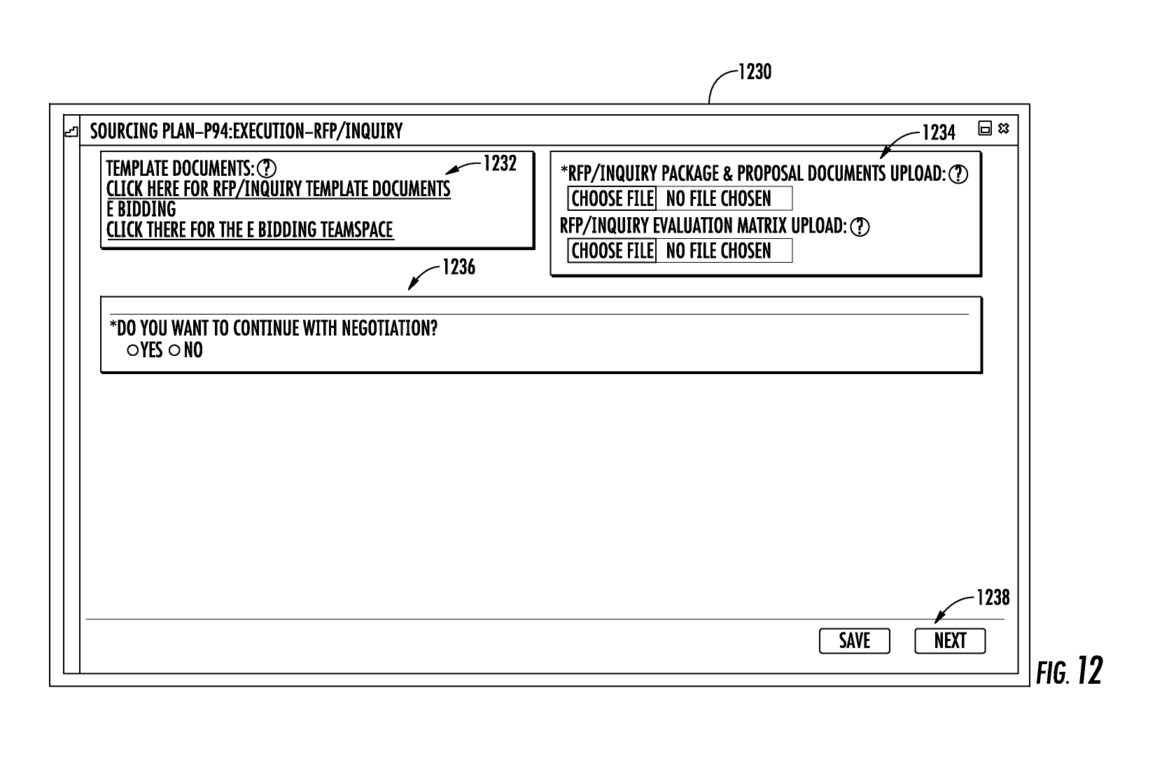

FIG. 12 depicts a user interface 1230 for a request for price inquiry, according to embodiments described herein. In response to selection of the next option 1140 from FIG. 11, the user interface 1230 may be provided. As illustrated, the user interface 1230 includes a templates section 1232, a documents section, and a continue section 1236. Specifically, the templates section 1232 includes an option to access at least one templated document for providing an RFP, RFQ, and/or other similar templates. An option for providing reference documents and/or a team space for electronic bidding may also be provided. The documents section 1234 may include one or more documents to upload. The documents may include an RFP document, an RFP evaluation matrix, and/or other document related to the project. The continue section includes an option related to whether the user wishes to proceed with the negotiation. A next option 1238 is also provided for advancing to a subsequent user interface.

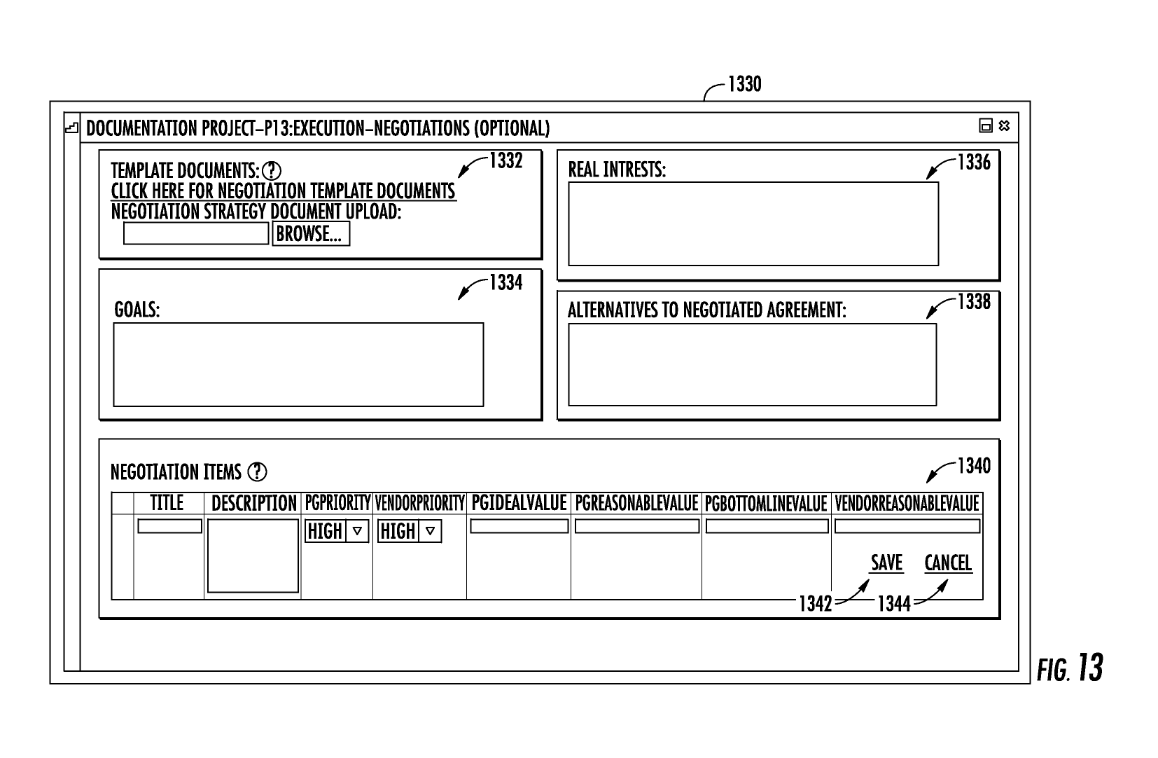

FIG. 13 depicts a user interface 1330 for providing negotiation information, according to embodiments described herein. In response to selection of the next option 1238, the user interface 1330 may be provided. Specifically, the user interface 1330 includes a template section 1332, a goals section 1334, an interests section 1336, an alternatives section 1338, and a negotiation items section 1340. The template section 1332 includes an option to upload a negotiation strategy document and/or other document related to the project. The goals section 1334 may include a goals field for the user to identify one or more goals associated with the project. The interests section 1336 may include a field for the user to identify interests associated with the project. The alternatives section 1338 may provide a field for indicating alternatives to the negotiated agreement that may be possible. The negotiation items section 1340 may include a title option, a description option, a priority option, a vendor priority option, an ideal value option, a reasonable value, a bottom line value option, and a vendor reasonable value. A save option 1342 is provided for saving the project. A cancel option 1344 may be provided for canceling the project.

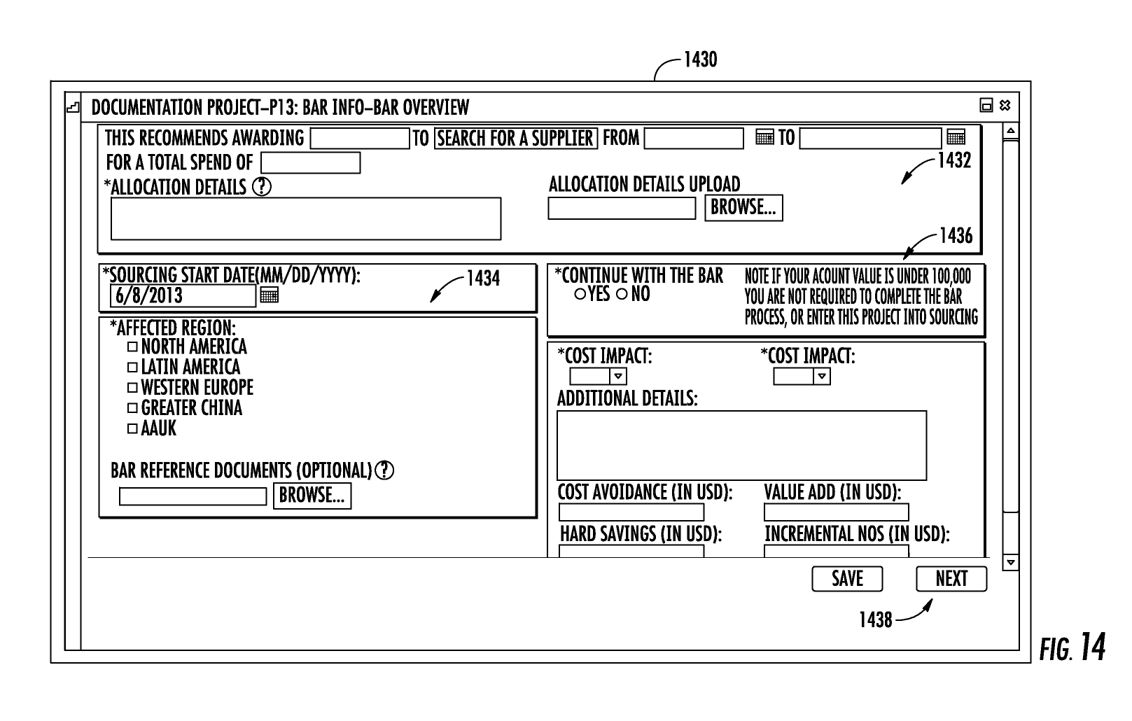

FIG. 14 depicts a user interface 1430 for providing details related to a project, according to embodiments described herein. As illustrated, the user interface 1430 includes an award section 1432, a time and region section 1434, and a details section 1436. The award section 1432 includes an option for providing a recommendation regarding whether to award the project to a predetermined vendor and/or supplier. A date field may also be provided, as well as a spend field. A details field and an upload option may also be provided for providing additional information and/or uploading a document related to the project.

Included in the region section are a start date field and a region option for identifying the region that the project may occur. Based on the selected region, one or more laws may apply to the project, which embodiments described herein may be configured to identify and ensure compliance with a policy. As an example, if the region was a jurisdiction, such as the United States, predetermined U.S. importation, tax, and/or other regulations may be utilized to determine a policy and a proper action for following the policy. A documents option may be provided for uploading documents associated with the region.

Included in the details section 1436 are a continue option, a cost impact option, a cash impact option, an additional details field, a cost avoidance field, a value add field, a hard savings field, and an incremental cost field. A next option 1438 is also provided for advancing to a subsequent user interface.

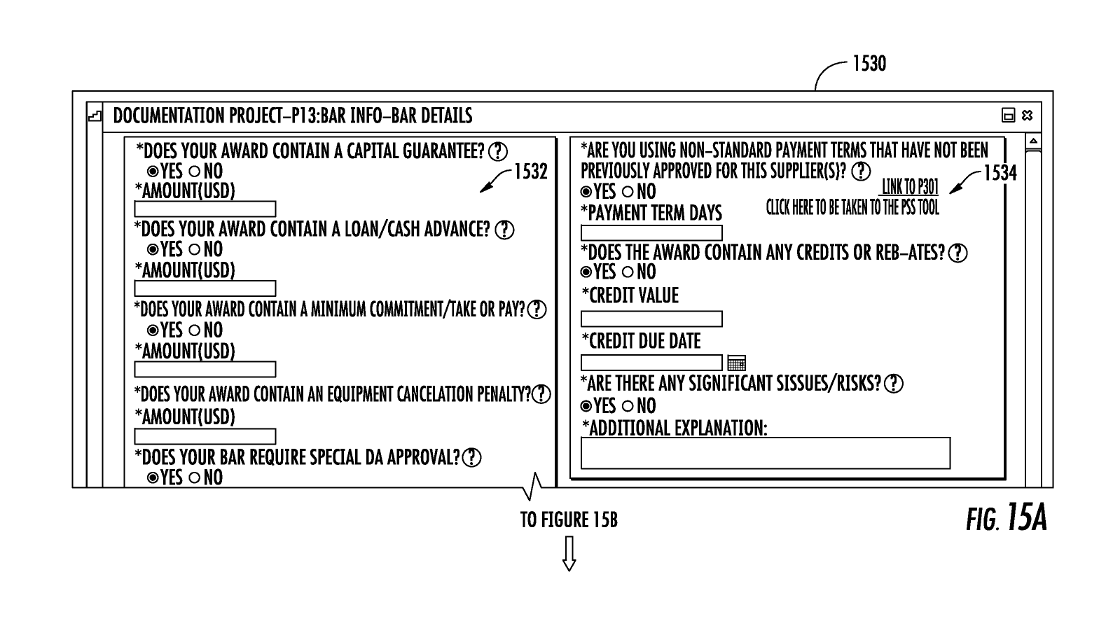

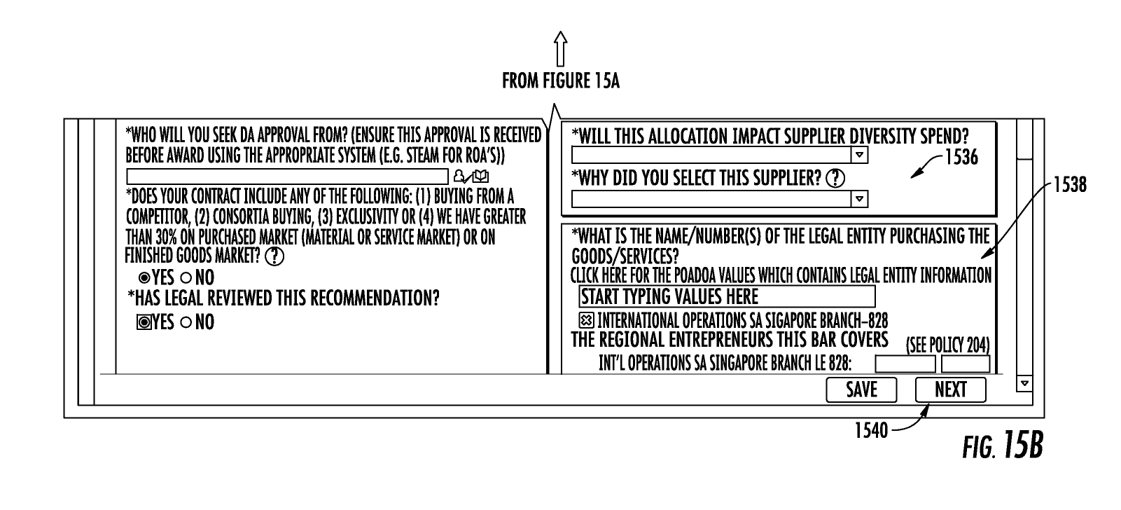

FIGS. 15A-15B depict a user interface 1530 for providing additional details related to the project, according to embodiments described herein. Specifically depicted in FIG. 15A, in response to selection of the next option 1438, the user interface 1530 may be provided. As illustrated, the user interface 1530 may include a financial section 1532, a payment section 1534, and a supplier section 1536. The financial section 1532 may include a capital guarantee option for identifying whether the award includes a capital guarantee and, if so, an amount of the capital guarantee. Also included is a cash advance option for identifying whether a cash advance will be provided as well as an amount of the cash advance. A minimum commitment option may be provided for identifying whether the vendor requires a minimum commitment, as well as an amount of the minimum commitment. A cancellation option is also provided for identifying whether the award includes an equipment cancelation penalty and if so, what amount that penalty is. A special approval option is provided for identifying whether special approval is acquired for this award. A conflict option may also be provided to identify whether there are any potential business conflicts with the project. A legal review option is also provided for identifying whether an attorney has reviewed the recommendation.

Additionally, the payment section 1534 includes non-standard payment option for identifying whether a non-standard form of payment will be utilized for this award. A term option may also be provided for identifying a payment term for the project. A credit option may be provided for identifying any credits or rebates associated with the project. A value of that credit may also be provided, as well as a due date for the credit. A risks option may be provided or identifying whether any risks are associated with the project, as well as a field for elaborating on those risks.

As depicted in FIG. 15B, the supplier section 1536 may include a diversity spend to identify whether the award will affect any diversity spend budgets. A reason option may also be provided for identifying a reason that the supplier was selected. A legal entity section 1538 may be provided to identify the actual legal entity that is entering into the agreement. A next option 1540 is also provided for navigating to a subsequent user interface.

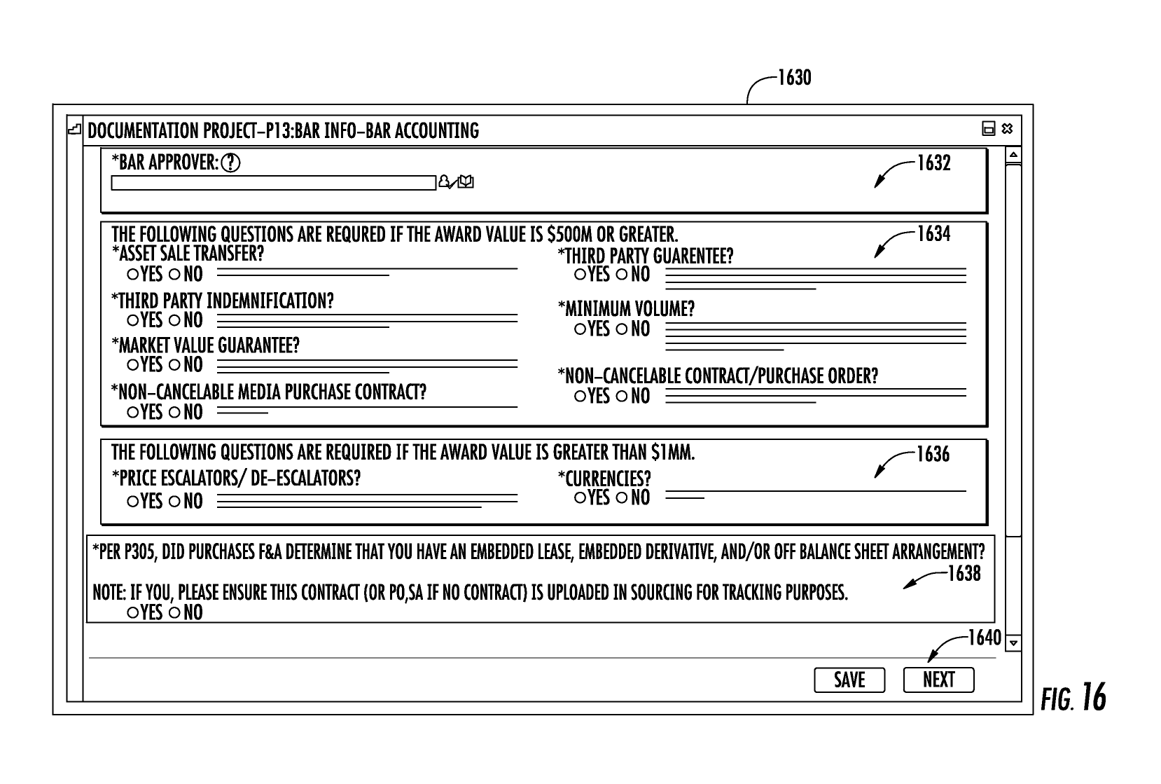

FIG. 16 depicts a user interface 1630 for providing accounting information related to a project, according to embodiments described herein. In response to selection of the next option 1540 from FIG. 15, the user interface 1630 may be provided. As illustrated, the user interface 1630 may include an approver section for the user to identify an approver of the project. A first legal questionnaire section 1634 may also be provided for identifying whether there is an asset sale transfer, third party indemnification, market value guarantee, non-cancelable media purchase contract, third party guarantee, minimum volume, and/or non-cancelable purchase order. A second legal questionnaire section 1636 may also be provided and may include options related to whether there are any price escalators or currencies that will be utilized in the project. Also included is embedded option for identifying whether an embedded lease, embedded derivative, off balance sheet arrangement and/or other arrangement is part of the project. A next option 1640 may also be provided for navigating to a subsequent user interface.

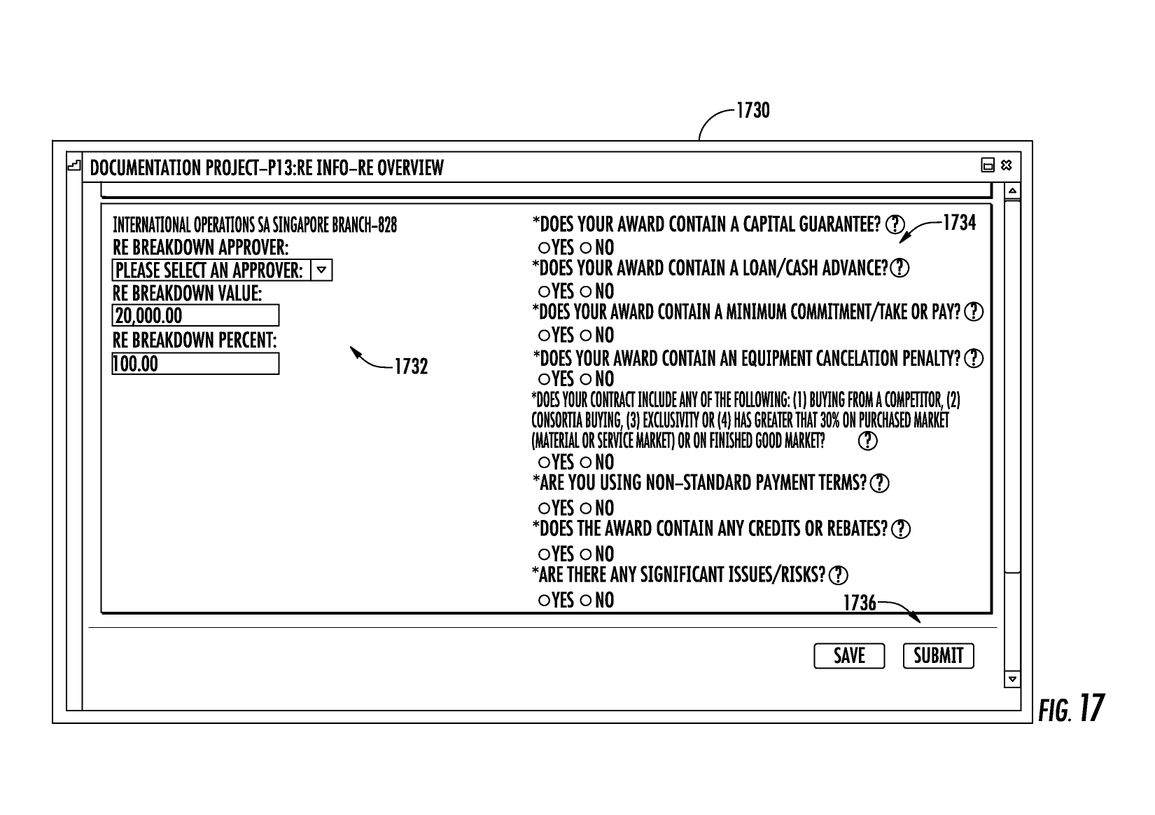

FIG. 17 depicts a user interface 1730 for providing overview information related to a project, according to embodiments described herein. In response to selection of the next option 1638 from FIG. 16, the user interface 1730 may be provided. The user interface 1730 includes a geographic section 1732, which provides an option for a geographic approver, a breakdown value option, and a breakdown percentage option. A details section 1734 includes an option to identify whether the project includes a capital guarantee, a cash advance, a minimum commitment, a cancelation penalty, a conflict option, a non-standard payment, a credits option, and a risk options. Depending on the particular embodiment, these options may be automatically populated from options selected in previous interfaces. A submit option 1736 may be provided for submitting the project.

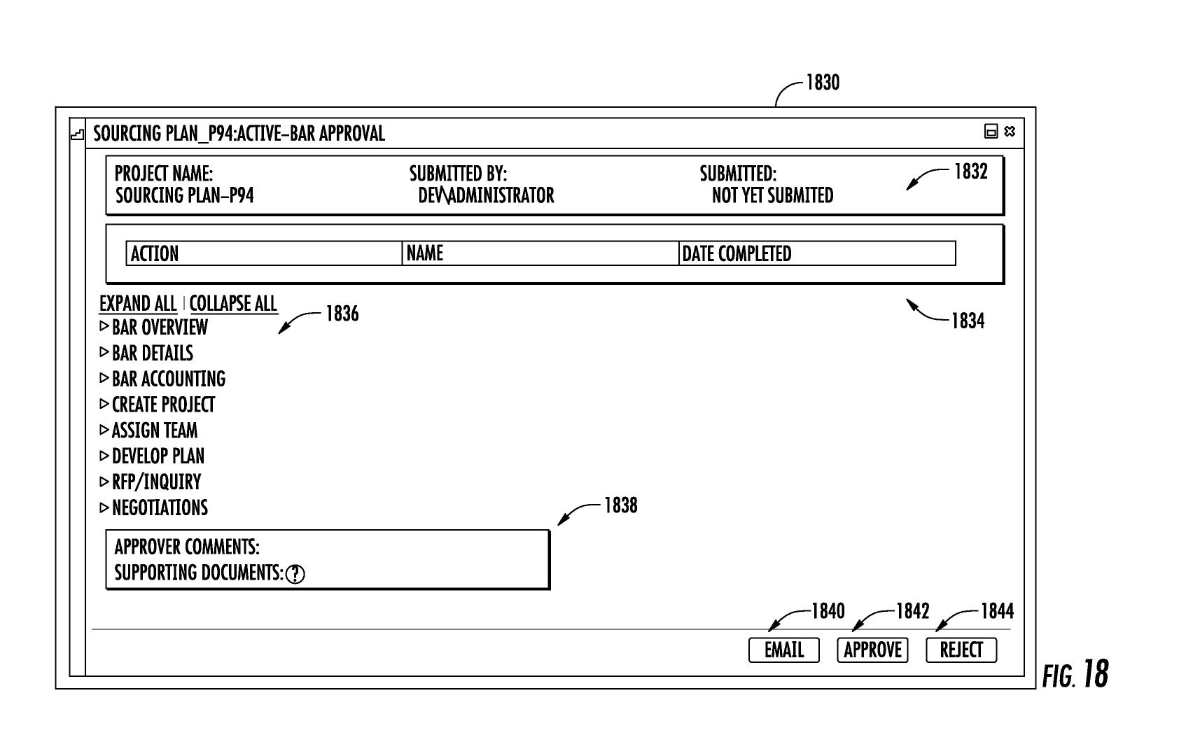

FIG. 18 depicts a user interface 1830 for providing approval information related to a project, according to embodiments described herein. As illustrated, once the project has been submitted, the user interface may be provided to the identified approver for reviewing, approving, and/or rejecting. Specifically, an overview section 1832 may be provided for providing a project name, a submitted by identifier, and a status identifier. A timeline section 1834 may also be provided for providing a listing of the actions that have been performed, the name of the person that performed those actions, and a date the action was completed. A details section 1836 may also be provided for providing the information that was entered via one or more of the user interfaces 330-1730 (FIGS. 3-17). A comments section 1838 may also be provided for the approver to identify reasons that the project and/or strategy is being approved or denied, as well as an option to provide supporting documents. Based on the review of the approver, the approver may select an email option 1840 for emailing the user; an approve option 1482 for approving the project and/or strategy; and/or a reject option 1844 for rejecting the project and/or strategy.

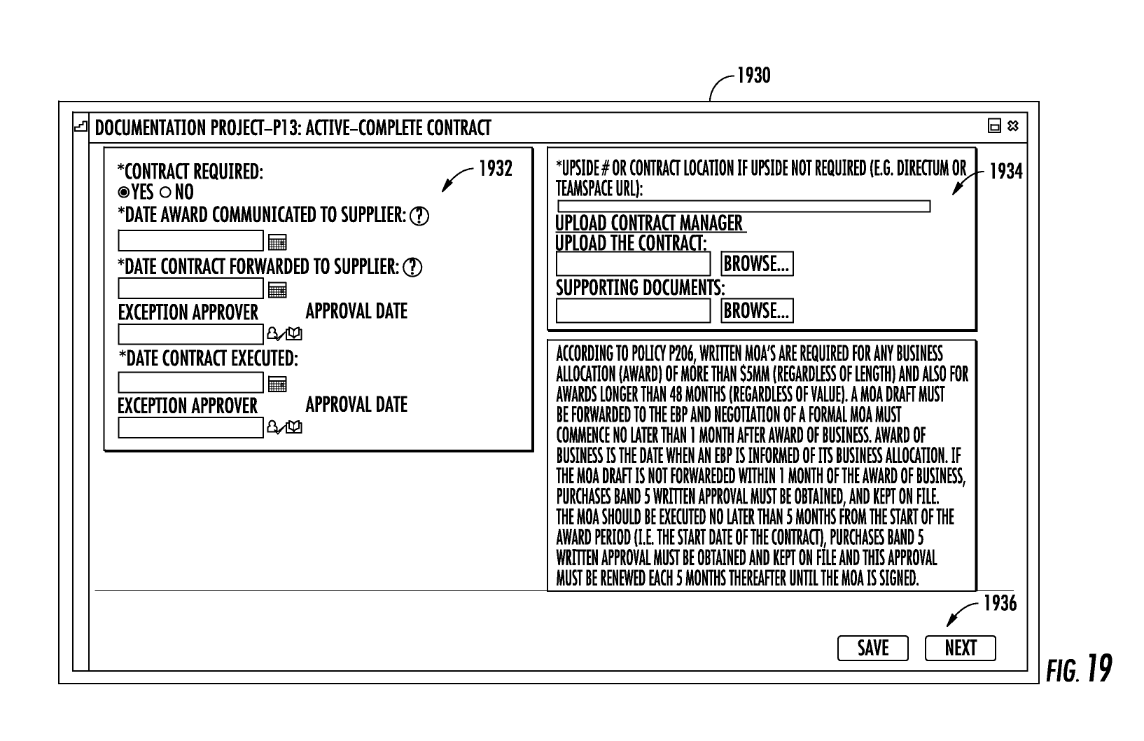

FIG. 19 depicts a user interface 1930 for providing completion data related to a contract of a project, according to embodiments described herein. Before, during, or after approval of the project, the user may proceed with execution of any contract associated with the project and/or award of business. Accordingly, the user interface 1930 may include a contract section 1932, which includes a contract option for identifying whether a contract is required. If so, an option for identifying the date the award was communicated to the supplier may be provided, as well as a date the contract was forwarded to the supplier, an option to identify an approval date of the approver, an option to identify a date the contract was executed, and a date that the approver approved the executed contract.

A documents section 1934 may also be provided, which may include a contract location field, a contract manager option, an upload contract option, and an upload supporting documents option. A next option 1936 may also be provided for proceeding to a subsequent user interface.

In response to selection of the upload contract manager option and/or other triggering action indicating that a contract is to be utilized, a contract creation tool may be provided. Specifically, the contract creation tool may receive at least a portion of the information that has been entered in the preceding user interfaces for utilization in the contract. As an example, the user may have entered information in the previous interfaces regarding party names, date of contract, duration of contract, purchase items, price, jurisdiction, and/or other items. By retrieving this information, a contract can be developed. The contract creation tool may also provide additional fields and/or questions for the user to answer, if some required information is missing. Regardless, once the contract is developed and approved by the user, the contract may be sent to a third party, such as a supervisory, legal authority, etc. If the contract is approved by the third party, the legal authority may make the contract again available to the user. The user may then access the contract via the upload contract option. If the user has changes to the contract, the user may select the contract manager option to contact the legal authority regarding the changes. Based on a decision by the legal authority, the contract may be changed and made again available for access by the user. Embodiments may additionally provide mechanisms for obtaining signatures on the contract. The contract may then automatically be linked with the project and/or strategy. Thus, information regarding termination dates, renewal dates, termination requirements, etc. may be associated with the project and/or strategy. Reminders for these dates and/or other criteria may also be provided.

It should also be understood that the contract creation tool may create reports associated with this contract, a plurality of contracts, contracts associated with a project, and/or contracts associated with a strategy. Similarly, some embodiments may be configured to provide searching functionality for this stored information.

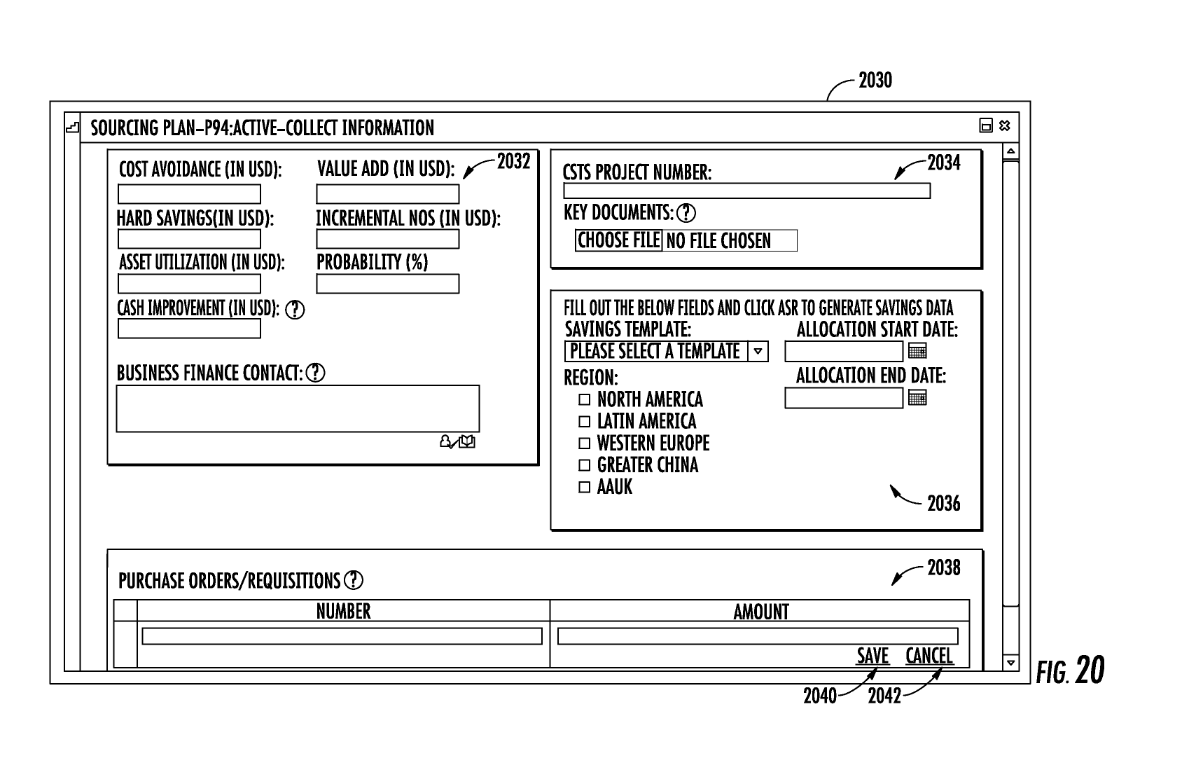

FIG. 20 depicts a user interface 2030 for providing collection information related to a project, according to embodiments described herein. In response to selection of the next option 1936 from FIG. 19, the user interface 2030 may be provided. As illustrated, the user interface 2030 includes a general collection section 2032, a project number section 2034, a savings section 2036, and a purchase orders section 2038. The general collection section 2032 includes a cost avoidance field, a value add field, a hard savings field, and incremental savings field, an asset utilization field, a provability field, a cash improvement field, and a business finance contact field.

The project number section 2034 may include a project number field and a key documents option for uploading and/or identifying documents that may be related to the project and/or collection for the project. The savings section 2036 may include a savings template option, an allocation start date option, an allocation end date option, and region option. The purchase orders section 2038 may provide purchase orders associated with the project, as well an amount for those purchase orders. A save option 2040 may be provided for saving the data entered into the user interface 2030. A cancel option 2042 may be selected for canceling the data entered.

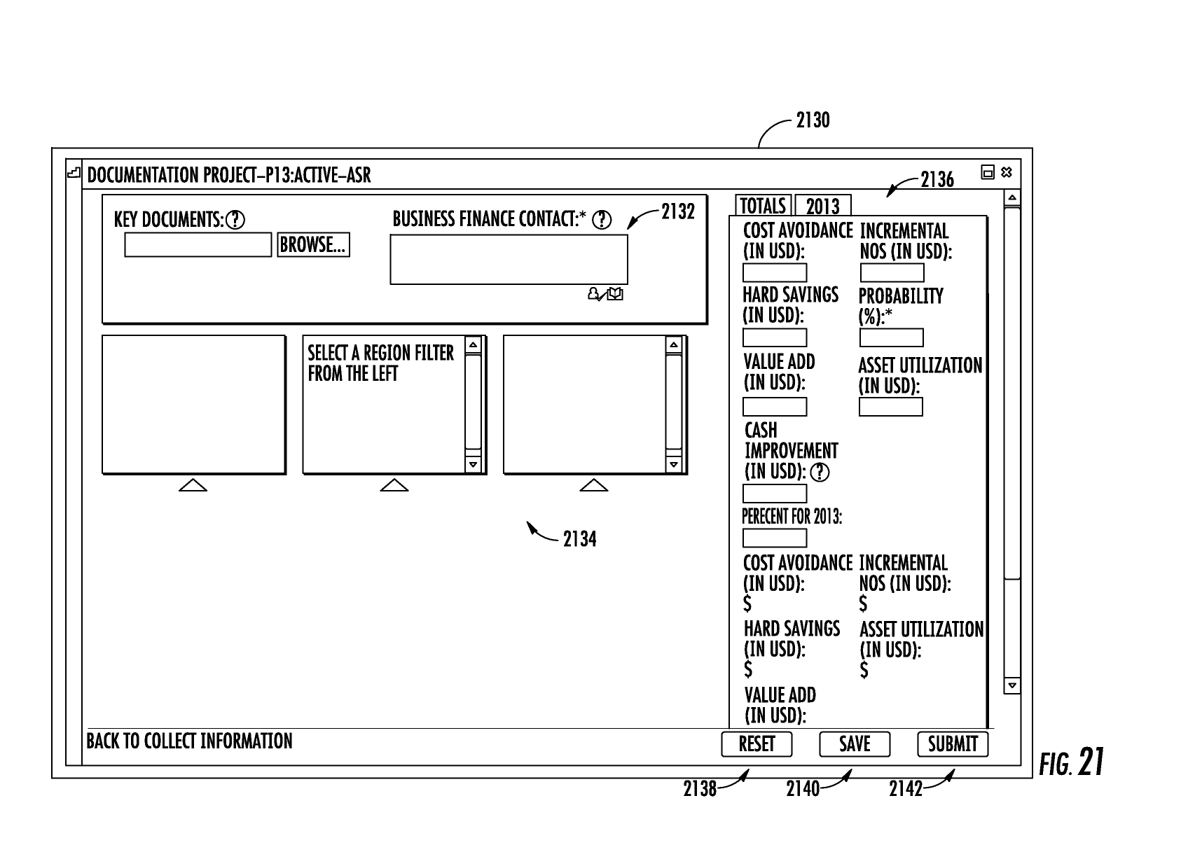

FIG. 21 depicts a user interface 2130 for providing cost information related to a project, according to embodiments described herein. As illustrated, the user interface 2130 may include a contacts section 2132, a filter section 2134, and a cost section 2136. The contacts section 2132 may include a documents option for uploading key documents for the project, as well as a contact field for identifying a business contact associated with the project. The filter section 2134 includes options for implementing filters to locate one or more other documents associated with the project. The cost section 2136 provides a cost avoidance field, an incremental cost field, a hard savings field, a probability field, a value add field, an asset utilization field, a cash improvement field, and a percent per year field. These fields may be populated and the user may select a reset option 2138, a save option 2140, and/or a submit option 2142. This information may additionally be entered based on year (or other time designation) and/or for the length of the project.

By populating the fields and executing the desired filters, cost avoidance, savings, value added, incremental costs, asset utilization, cash improvement, and/or other information may be provided for each of the categories of geographies or other segments selected.

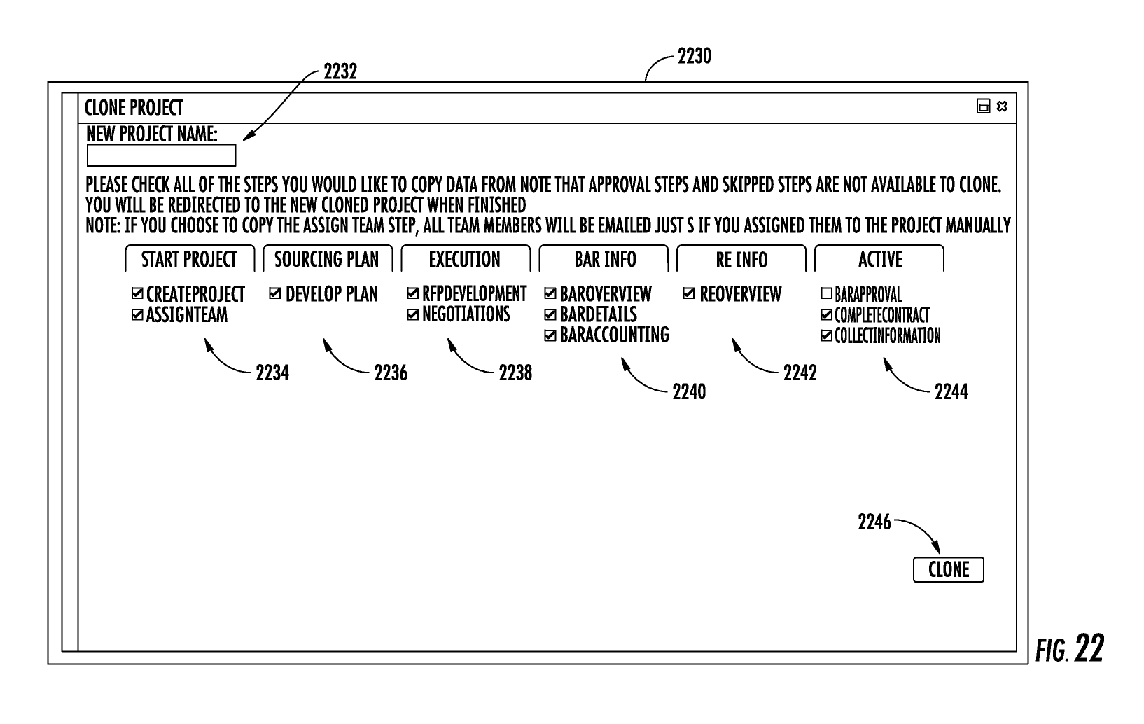

FIG. 22 depicts a user interface 2230 for cloning a project, according to embodiments described herein. As illustrated, if the user wishes to clone an existing project, the user may enter a new project name in the name field 2232. A start project section 2234 may be provided, which includes a create project option and an assign team option. By selecting one or more of these options, the cloned project will mirror the selections of the original project on those respective portions. Similarly, a sourcing plan section 2236 includes a develop plan option. An execution section 2238 includes an RFP development option and a negotiations option. A business allocation recommendation (BAR) info section 2240 includes an overview option, a details option, and a BAR accounting option. An RE info section 2242 includes an overview option. An active section 2444 includes an approval option, a complete contract option, and a collect information option. A clone option 2246 initiates creation of the new project.

It should be understood that while the options in FIG. 22 may directly relate to user interfaces described herein, this is not a requirement. Some embodiments may provide options for cloning portions of a user interface and/or other segment of the information in a project and/or strategy.

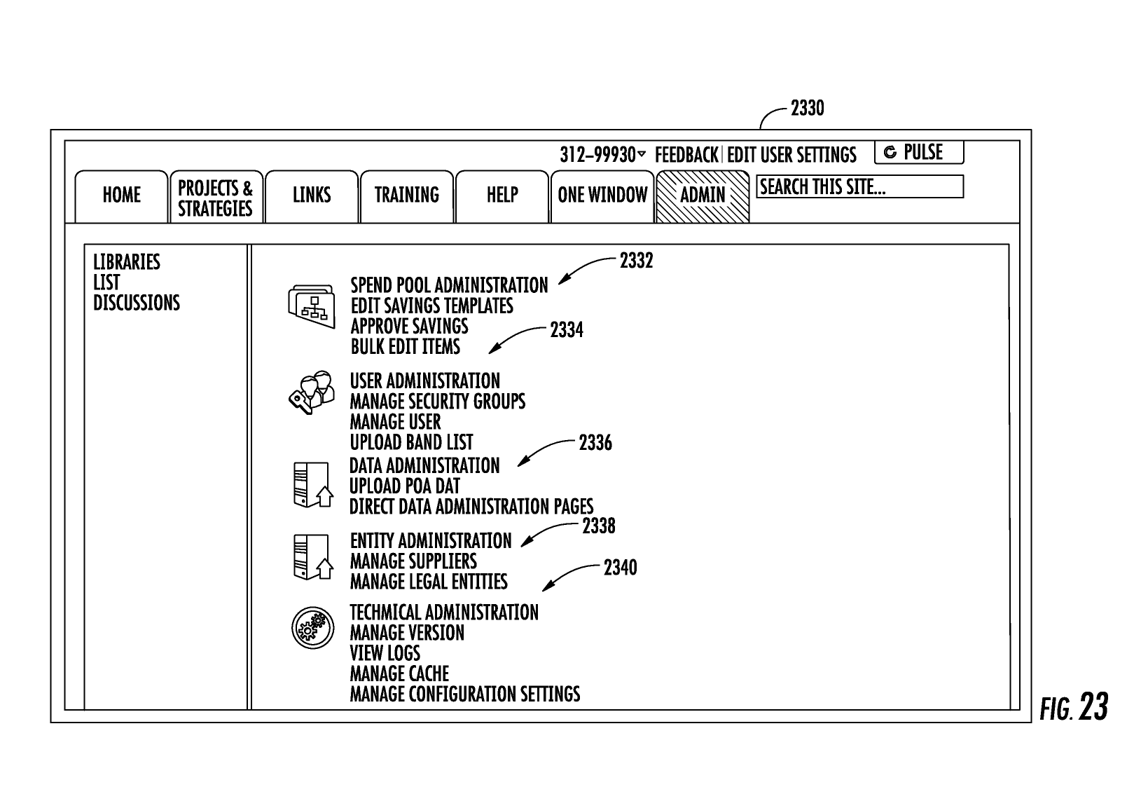

FIG. 23 depicts a user interface 2330 for providing an administrator portal, according to embodiments described herein. In response to selection of the admin option 366 from FIG. 3, the user interface 2330 may be provided. As illustrated, the user interface 2330 may be implemented as an administrator interface and may include a spend pool administration section 2332, with an edit savings templates option, an approve savings option, and a bulk edit items option. A user administration section 2334 may be provided, which includes a manage security groups option, a manage user option, and an upload band list option. A data administration section 2336 may be provided and includes an upload power of attorney data option, and a direct data administration pages option. An entity administration section 2338 may be provided and may include a manage suppliers option and a manage legal entities option. A technical administration section 2340 may be provided, which includes a manage versions option, a view logs option, a manage cache option, and a manage configuration settings option.

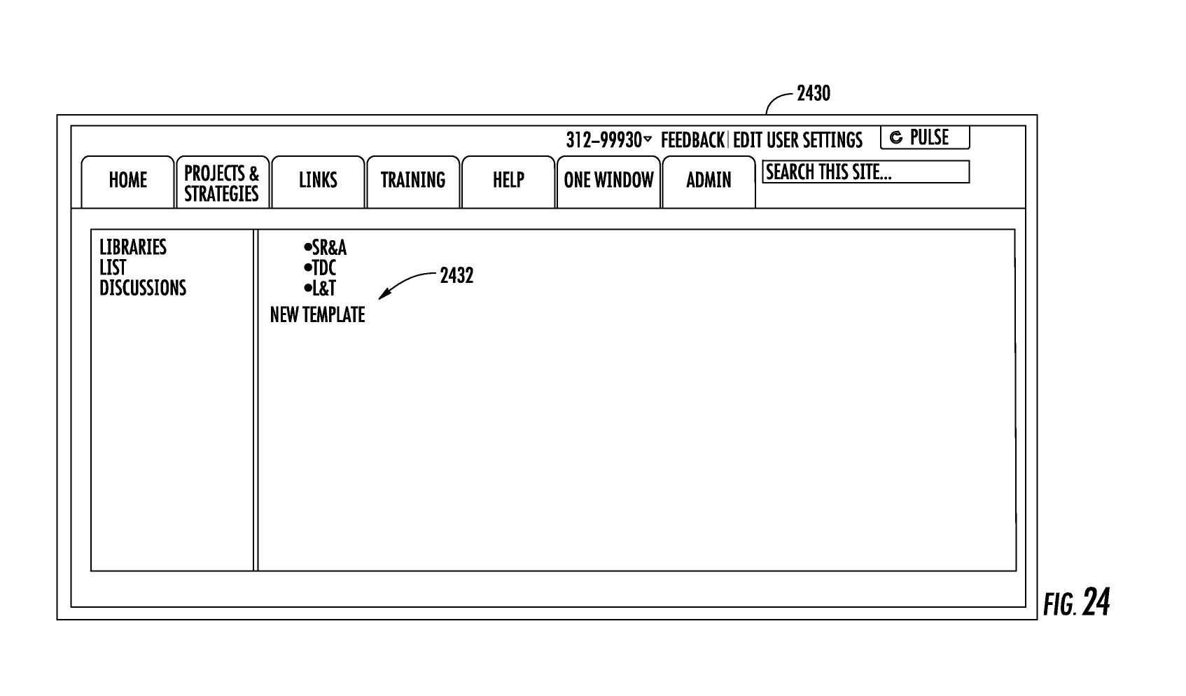

FIG. 24 depicts a user interface 2430 for an administrator to create a new template for use in a project and/or strategy, according to embodiments described herein. In response to selection of the edit savings templates option from FIG. 23, the user interface 2430 may be provided. As illustrated, the user interface 2430 includes a listing of the templates that are currently available, as well as a template option 2432 to create a new template.

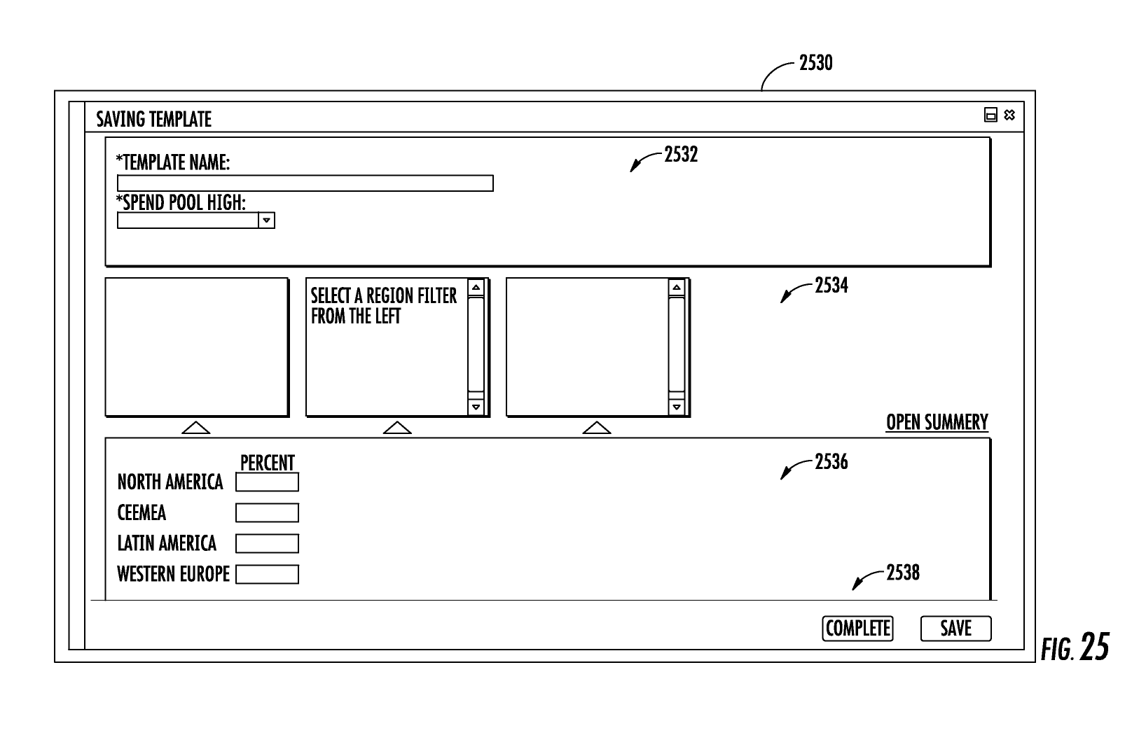

FIG. 25 depicts a user interface 2530 for creating a new template, according to embodiments described herein. In response to selection of the template option 2432 from FIG. 24, the user interface 2530 may be provided. As illustrated, the user interface 2530 may include a general information section 2532 with a name field and a spend pool high option. A filter section 2534 may be provided for identifying filters that may be utilized for the template. A geography section 2536 may include a plurality of options for identifying respective percentages that the template will apply to various geographic regions. A complete option 2538 may be provided for completing the template.

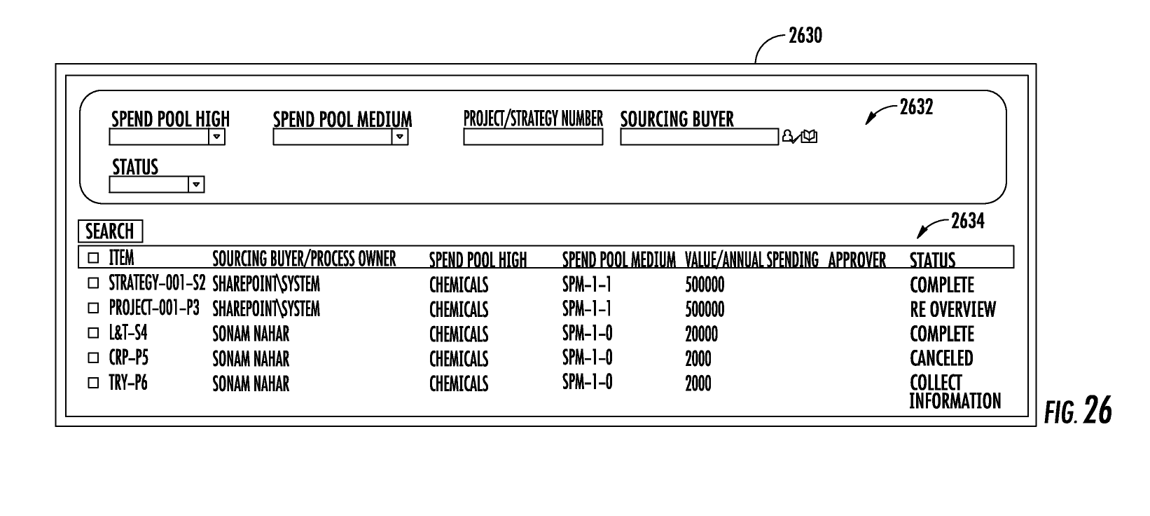

FIG. 26 depicts a user interface 2630 for searching for a project and/or strategy, according to embodiments described herein. As illustrated, the user interface 2630 may include a search field section 2632 for identifying one or more criteria for searching a project and/or strategy. The fields may include a spend pool high field, a spend pool medium field, a project and/or strategy number field, a sourcing buyer field, a status field and/or other fields. In response to executing the search, a search results section 2634 may be provided with projects and/or strategies that correspond to the entered search criteria.

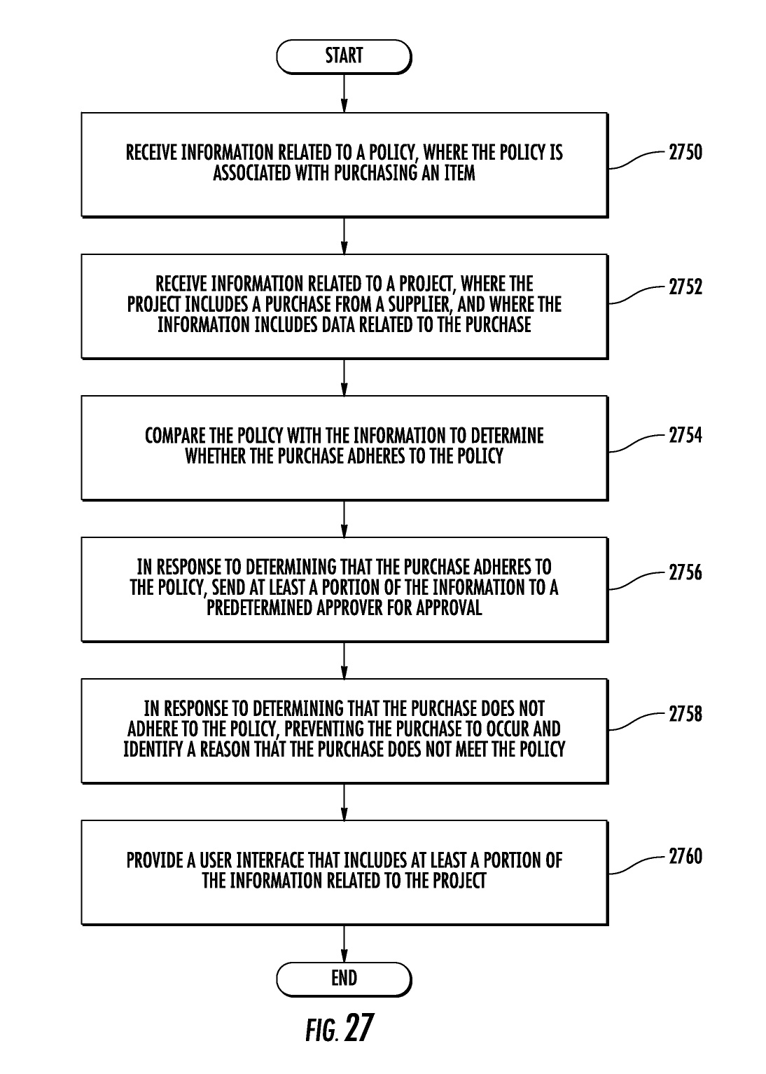

FIG. 27 depicts a flowchart for managing business award workflow, according to embodiments described herein. As illustrated in block 2750 information related to a policy may be received, where the policy is associated with purchasing an item. In block 2752, information may be received relative to a project, where the project includes a business award to a supplier, and where the information includes data related to the business award. In block 2754, the policy may be compared with the information to determine whether the business award adheres to the policy. In block 2756, in response to determining that the business award adheres to the policy, at least a portion of the information may be sent to a predetermined approver for approval. In block 2758, in response to determining that the business award does not adhere to the policy, the business award may be prevented from occurring and a reason that the business award does not meet the policy may be provided. In block 2760, a user interface may be provided that includes at least a portion of the information related to the project.

It should be understood that the embodiments described herein provide a workflow for a project and/or strategy that includes award of business for goods and/or services. Specifically, a user who wishes to business award goods is directed through a plurality of user interfaces that request information regarding the project and/or strategy to ensure that the underlying business award complies with predetermined policies of the entity. As an example, if the user wishes to make a purchase of widgets in the United Kingdom from a U.S. company, there may be export laws, tax laws, and/or internal policies to which the purchase must comply. Accordingly, embodiments described herein provide templated documents and request templated documents to ensure that those policies are followed. Depending on the particular embodiment, the user may be prevented from making the purchase (such as automatically if a determination is made that a document is missing or via an administrator failing to provide approval of the project).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A system for managing business award workflow, comprising:
a memory component that stores logic that, when executed by a processor, causes the processor to perform at least the following:
receive information related to a policy, wherein the policy is associated with purchasing an item;
receive information related to a project, wherein the project includes a business award to a supplier, and wherein the information includes data related to the business award;
compare the policy with the information to determine whether the business award adheres to the policy;
in response to determining that the business award adheres to the policy, send at least a portion of the information to a predetermined approver for approval;
in response to determining that the business award does not adhere to the policy, identify a reason that the business award does not meet the policy; and
provide a user interface that includes at least a portion of the information related to the project, including an indication regarding whether the business award adheres to the policy.

2. A method for managing business award workflow, comprising:
receiving, by a computing device, information related to a policy, wherein the policy is associated with purchasing an item;
receiving, by the computing device, information related to a project, wherein the project includes a business award to a supplier, and wherein the information includes data related to the business award;
comparing, by the computing device, the policy with the information to determine whether the business award adheres to the policy;
in response to determining that the business award adheres to the policy, sending, by the computing device, at least a portion of the information to a predetermined approver for approval;
in response to determining that the business award does not adhere to the policy, preventing, by the computing device, the business award to occur and identify a reason that the business award does not meet the policy; and
providing, by the computing device, a user interface that includes at least a portion of the information related to the project, including an indication regarding whether the business award adheres to the policy, wherein the user interface further comprises an option to create a new project.

3. A non-transitory computer-readable medium for managing business award workflow that stores logic that causes a computing device to perform the following:
receive information related to a policy, wherein the policy is associated with purchasing an item;
receive information related to a strategy, wherein the strategy includes a plurality of projects, at least one of the plurality of projects including a business award to a supplier, and wherein the information includes data related to the business award;
compare the policy with the information to determine whether the business award adheres to the policy;
in response to determining that the business award adheres to the policy, send at least a portion of the information to a predetermined approver for approval;
in response to determining that the business award does not adhere to the policy, identify a reason that the business award does not meet the policy; and
provide a user interface that includes at least a portion of the information related to the strategy, including an indication regarding whether the business award adheres to the policy, wherein the user interface further comprises an option to add a new project to the strategy.
